(19) United States
(12) Patent Application Publication
(10) Pub. No.: US 2026/0084396 A1
(43) Pub. Date: Mar. 26, 2026

(54) Nonwoven Material With High Strength and a Soft Feel and Laminates Made Therefrom

(71) Applicant: Kimberly-Clark Worldwide, Inc., Neenah, WI (US)

(72) Inventors: Alan Un, Alpharetta, GA (US); Shawn E. Jenkins, Alpharetta, GA (US); Esfandiar Khatiblou, Alpharetta, GA (US); J. David Tucker, Canton, GA (US); Glynis A. Walton, Roswell, GA (US); Eric E. Lennon, Roswell, GA (US); Billy D. Arnold, Cumming, GA (US)

(21) Appl. No.: 19/114,241

(22) PCT Filed: Sep. 28, 2023
(86) PCT No.: PCT/US2023/033943

§ 371 Date: Mar. 21, 2025

Related U.S. Application Data
(60) Provisional application No. 63/411,768, filed on Sep. 30, 2022.

(51) Int. Cl. B32B 5/02; B32B 5/08; B32B 5/26; B32B 27/12

(52) U.S. Cl. CPC B32B 5/022; B32B 5/08; B32B 5/267; B32B 27/12; B32B 2262/0253; B32B 2262/124; B32B 2307/51; B32B 2307/718

(57) ABSTRACT

A nonwoven material is disclosed having an excellent balance between strength and softness. The nonwoven material can be made from spunbond layers and can include at least one strength-building layer combined with at least one softness enhancing layer. In one aspect, the nonwoven material can be incorporated into an elastic laminate for use in absorbent articles.

### RELATED APPLICATIONS

The present application is based upon and claims priority to U.S. Provisional Patent Application Ser. No. 63/411,768, having a filing date of Sep. 30, 2022, which is incorporated herein by reference in its entirety.

### BACKGROUND

Spunbond nonwoven fabrics comprise bonded webs of continuous filaments formed by extruding a molten thermoplastic polymer from a plurality of fine capillaries as molten filaments. The molten filaments are quenched to at least partially solidify them and then they are attenuated by one or more high velocity air streams which reduce their diameter. By way of example, spunbond filament nonwoven webs and processes for making the same are disclosed in U.S. Pat. No. 4,340,563 to Appel et al, U.S. Pat. No. 5,382,400 to Pike et al.; U.S. Pat. No. 8,246,898 to Conrad et al. and U.S. Pat. No. 8,333,918 to Lennon et al.

Spunbond filament nonwoven webs are commonly used in a wide range of products. The reason for this extensive and varied use in part relates to the ability of spunbond filament nonwoven webs to provide a desirable combination of properties. Further, the cost of manufacture of spunbond filament webs is relatively low as compared to other materials with like properties such as traditional knitted or woven fabrics. As a result, spunbond filament nonwoven webs have been found to be particularly useful in relation to the manufacture of single-use or limited-use products; e.g. absorbent personal care products, wipes, protective apparel, geotextiles, tarpaulins, etc.

The properties of spunbond webs can be varied by changing the polymer composition that is used to produce the web. For example, producing spunbond webs from elastomeric materials can result in webs having a soft handfeel and excellent drapeability characteristics. Elastic spunbond webs, however, tend to lack strength and durability in relation to spunbond webs made from other polymer materials.

In view of the above, a need exists for a nonwoven web that not only has a soft handfeel but also has excellent strength properties. A need also exists for an elastic laminate that can incorporate a nonwoven web as described above.

### SUMMARY

In general, the present disclosure is directed to producing nonwoven webs having a good balance of softness and strength. In one aspect, for instance, nonwoven webs are made according to the present disclosure including a facing made from a soft-elastic spunbond web. The nonwoven web further includes at least one other strength-building layer, which can also be made from a spunbond web. In one embodiment, the strength-building layer can be produced from a fine fiber polymer layer. The nonwoven web is particularly well suited for producing elastic laminates in which the strength-building layer is positioned against an elastic film with the elastic layer forming a top layer of the laminate that has soft, cloth-like properties.

In one embodiment, for instance, the present disclosure is directed to a nonwoven material. The nonwoven material includes a strength-building layer comprising spunbond fibers randomly arranged to form a web. The spunbond fibers have a denier of less than about 2 and are made from a non-elastomeric polymer. For example, the non-elastomeric polymer can be a polypropylene polymer and can comprise at least about 70%, such as at least about 80%, such as at least about 90% of the strength-building layer. The denier of the spunbond fibers contained in the strength-building layer can be less than about 1.5, such as less than about 1.3, such as less than about 1, such as less than about 0.9, such as less than about 0.85.

The nonwoven material further includes a softness enhancing layer comprising spunbond fibers randomly arranged to form a web. The softness enhancing layer can be incorporated into the nonwoven material so as to form a top layer of the material. In one aspect, the softness enhancing layer can be bonded to the strength-building layer. The spunbond fibers in the softness enhancing layer can comprise elastomeric fibers. For example, the elastomeric fibers can be made from elastomeric bicomponent fibers including a core surrounded by a sheath. The core of the bicomponent fibers, in one embodiment, can be formed from a polypropylene-based elastomer alone or in combination with a secondary amide. The polypropylene-based elastomer can comprise an ethylene copolymer, an α-olefin copolymer, or a combination thereof. The sheath, on the other hand, can comprise a non-elastomeric polymer. For instance, the sheath can be made from a polyethylene polymer.

As described above, the core can contain a secondary amide, which can be a fatty acid amide. The secondary amide, for instance, can have a chemical structure as follows:

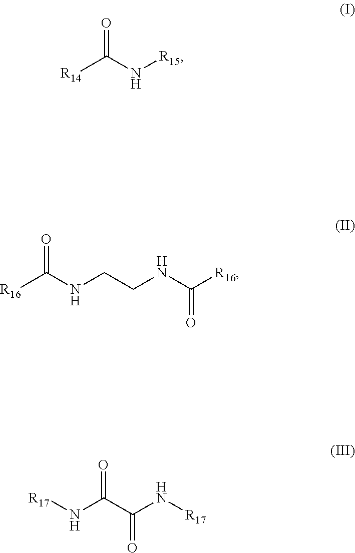

wherein,
R₁₄, R₁₅, R₁₆, and R₁₈ are independently selected from C₇-C₂₇ alkyl groups and C₇-C₂₇ alkenyl groups; and
R₁₇ is selected from C₈-C₂₈ alkyl groups and C₈-C₂₈ alkenyl groups.

In one aspect, the elastomeric bicomponent fibers of the softness enhancing layer can include a core made from at least two elastomeric polymers either alone or in combination with a secondary amide.

The basis weight of the nonwoven material made in accordance with the present disclosure can vary depending upon the particular application and the desired result. In general, the basis weight of the nonwoven material can be anywhere from about 5 gsm to about 300 gsm, including all increments of 1 gsm therebetween. In certain embodiments, the basis weight can be from about 5 gsm to about 170 gsm, such as from about 9 gsm to about 20 gsm. The weight ratio between the strength-building layer and the softness enhancing layer within the nonwoven material can be from about 1:3 to about 1.5:1, such as from about 1:2 to about 1.1:1.

The present disclosure is also directed to an elastomeric laminate containing the nonwoven material as described above. In one aspect, the elastomeric laminate can include an elastic backing that can be made from an elastic film or a plurality of parallel elastic filaments or ribbons. In one aspect, the strength-building layer can be adhered to the backing. The softness enhancing layer, on the other hand, can form an exterior surface of the elastomeric laminate.

Elastomeric laminates made according to the present disclosure can have an excellent balance of strength and softness properties. For instance, the elastomeric laminate can have a burst strength of greater than about 1800 g, such as greater than about 2200 g, such as greater than about 2500 g, such as greater than about 2800 g, such as greater than about 3000 g at a basis weight of from about 20 gsm to about 40 gsm. The laminate can have an average stretch-to-stop in a machine direction of greater than about 170%, such as greater than about 175%, and generally less than about 225% at a load of 2000 g. In addition to the above properties, the laminate can also display excellent softness properties. For instance, the TS7 of the laminate can be less than about 6, such as less than about 5.8, such as less than about 5.5, and generally greater than 2.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIGS. 1a and 1b are example fibers for use in nonwoven materials made according to the present disclosure;

FIG. 2 is an example schematic of an apparatus for forming an extensible facing;

FIG. 3 is an example of a schematic of an apparatus for forming a strength-building layer;

FIG. 4 is an example schematic of an apparatus for forming a nonwoven material in accordance with the present disclosure;

FIG. 5 is an example schematic of an apparatus for forming elastic laminates in accordance with the present disclosure; and

FIG. 6 is an example cross-sectional view of an elastic laminate that may be made in accordance with the present disclosure.

Repeat use of reference characters in the present specification and drawings is intended to represent the same or analogous features or elements of the present invention.

### Definitions

As used herein, the terms “about,” “approximately,” or “generally,” when used to modify a value, indicates that the value can be raised or lowered by 10%, such as, such as 7.5%, 5%, such as 4%, such as 3%, such as 2%, such as 1%, and remain within the disclosed aspect. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the term “elastomeric” and “elastic” and refers to a material that, upon application of a stretching force, is stretchable in at least one direction (such as the CD or MD direction), and which upon release of the stretching force, contracts/returns to approximately its original dimension. For example, a stretched material may have a stretched length that is at least 50% greater than its relaxed unstretched length, and which will recover to within at least 50% of its stretched length upon release of the stretching force. A hypothetical example would be a one (1) inch sample of a material that is stretchable to at least 1.50 inches and which, upon release of the stretching force, will recover to a length of not more than 1.25 inches. Desirably, the material contracts or recovers at least 50%, and even more desirably, at least 80% of the stretched length.

As used herein, the term “fibers” generally refer to elongated extrudates that may be formed by passing a polymer through a forming orifice, such as a die. Unless noted otherwise, the term “fibers” includes discontinuous fibers having a definite length (e.g., stable fibers) and substantially continuous filaments. Substantially continuous filaments may, for instance, have a length much greater than their diameter, such as a length to diameter ratio (“aspect ratio”) greater than about 15,000 to 1, and in some cases, greater than about 50,000 to 1.

As used herein the term “extensible” generally refers to a material that stretches or extends in the direction of an applied force (e.g., CD or MD direction) by about 50% or more, in some aspects about 75% or more, in some aspects about 100% or more, and in some aspects, about 200% or more of its relaxed length or width.

As used herein, the terms “necked” and “necked material” generally refer to any material that has been drawn in at least one dimension (e.g., machine direction) to reduce its transverse dimension (e.g., cross machine direction) so that when the drawing force is removed, the material may be pulled back to its original width. The necked material generally has a higher basis weight per unit area than the un-necked material. When the necked material is pulled back to its original width, it should have about the same basis weight as the un-necked material. This differs from the orientation of a film in which the film is thinned and the basis weight is reduced. The necking method typically involves unwinding a material from a supply roll and passing it through a brake nip roll assembly driven at a given linear speed. A take-up roll or nip, operating at a linear speed higher than the brake nip roll, draws the material and generates the tension needed to elongate and neck the material.

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

As used herein, the term “meltblown web” generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, the terms “machine direction” or “MD” generally refers to the direction in which a material is produced (e.g., the direction the material is conveyed during the forming/manufacturing process of the nonwoven material). The term “cross-machine direction” or “CD” refers to the direction perpendicular to the machine direction.

As used herein, the term “thermal point bonding” generally refers to a process performed, for example, by passing a material between a patterned roll (e.g., calender roll) and another roll (e.g., anvil roll), which may or may not be patterned. One or both of the rolls are typically heated.

As used herein, the term “ultrasonic bonding” generally refers to a process performed, for example, by passing a material between a sonic horn and a patterned roll (e.g., anvil roll). For instance, ultrasonic bonding through the use of a stationary horn and a rotating patterned anvil roll is described in U.S. Pat. No. 3,939,033 to Grgach, et al., U.S. Pat. No. 3,844,869 to Rust Jr., and U.S. Pat. No. 4,259,399 to Hill, which are incorporated herein in their entirety by reference thereto for all purposes. Moreover, ultrasonic bonding through the use of a rotary horn with a rotating patterned anvil roll is described in U.S. Pat. No. 5,096,532 to Neuwirth, et al., U.S. Pat. No. 5,110,403 to Ehlert, and U.S. Pat. No. 5,817,199 to Brennecke, et al., which are incorporated herein in their entirety by reference thereto for all purposes. Of course, any other ultrasonic bonding technique may also be used in the present disclosure.

As used herein “continuous filaments” means filaments formed in a substantially continuous, uninterrupted manner having indefinite length and having a high aspect ratio (length to diameter) in excess of about 10,000:1.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein “ethylene polymer” or “polyethylene” means a polymer having greater than 50 mol. % units derived from ethylene.

As used herein “olefin polymer” or “polyolefin polymer” means a polymer having greater than 50 mol. % units derived from an alkene, including linear, branched or cyclic alkenes.

As used herein “propylene polymer” or “polypropylene” means a polymer having greater than 50 mol. % units derived from propylene.

As used herein “personal care articles” means any and all articles or products used for personal health or hygiene including diapers, adult incontinence garments, absorbent pants and garments, tampons, feminine pads and liners, bodily wipes (e.g. baby wipes, perineal wipes, hand wipes, etc.), bibs, changing pads, bandages, and components thereof.

As used herein “protection articles” means all articles intended to protect a user or equipment from contact with or exposure to external matter including, for example, face masks, protective gowns and aprons, gloves, caps, shoe covers, equipment covers, sterile wrap (e.g. for medical instruments), car covers, and so forth.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a nonwoven material having at least two distinct layers. The layers include at least one strength-building layer combined with at least one softness enhancing layer. The strength-building layer, for instance, can be made from a non-elastomeric polymer that has relatively fine fibers. The softness enhancing layer, on the other hand, can be made from one or more elastomeric materials. The nonwoven material of the present disclosure has numerous uses and applications. In one aspect, for instance, the nonwoven material can be combined or attached to an elastic backing for producing laminates.

Nonwoven materials made according to the present disclosure offer various advantages and benefits. For instance, the nonwoven materials are relatively strong due to the strength-building layer. In addition, at least one exterior layer of the nonwoven material comprises the softness enhancing layer that is noticeably soft to the touch. Thus, nonwoven materials made according to the present disclosure have a unique balance between strength and softness.

### Softness Enhancing Layer

As described above, the nonwoven material of the present disclosure generally contains at least one softness enhancing layer and at least one strength-building layer. The softness enhancing layer forms a top or exterior surface of the nonwoven material. The softness enhancing layer is soft to the touch and can be formulated to have a cloth-like feel.

As will be described in more detail below, the polymers used to form the softness enhancing layer typically have a softening temperature that is higher than the temperature imparted during bonding and are extensible or elastomeric. In this manner, the polymers do not substantially soften during bonding to such an extent that the fibers of the softness enhancing layers become completely melt flowable. For instance, polymers may be employed that have a Vicat softening temperature (ASTM D-1525) of from about 100° C. to about 300° C., in some embodiments from about 120° C. to about 250° C., and in some embodiments, from about 130° C. to about 200° C. Exemplary high-softening point polymers for use in forming softness enhancing layers may include, for instance ExxonMobil™ PP3155 (inelastic) and Achieve™ Advanced PP3854 and Dow™ ASPUN 6850.

Extensible or elastomeric monocomponent and/or multicomponent fibers may be used to form the softness enhancing layers, e.g., facing. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. and so forth. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes.

In some implementations, the polymers of the multicomponent fibers of the softness enhancing layer are spunbond fibers made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. In some implementations, the core of the sheath-core bicomponent fibers include a polypropylene homopolymer or copolymer based on either Ziegler-Natta catalysts or single site catalysts and/or the sheath of the sheath-core bicomponent fibers include homopolymers, copolymers or mixtures thereof from ethylene, propylene, or styrenic derived polymers.

The basis weight of the softness enhancing layer may generally vary, such as from about 5 grams per square meter (“gsm”) to 200 gsm, in some embodiments from about 6 gsm to about 70 gsm, and in some embodiments, from about 8 gsm to about 35 gsm. In one aspect, the basis weight is less than about 30 gsm, such as less than about 25 gsm, such as less than about 20 gsm, such as less than about 15 gsm, such as less than about 12 gsm, such as less than about 10 gsm, such as less than about 9 gsm, such as less than about 8 gsm, such as less than about 7 gsm, and greater than about 4 gsm. In some embodiments, the nonwoven material of the present disclosure may include multiple softness enhancing layers. The softness enhancing layers, for instance, can be adjacent to one another in the nonwoven material and each softness enhancing layer can have the same basis weight or a different basis weight.

As described above, in some implementations the nonwoven web is made from monocomponent spunbond fibers. In other implementations the nonwoven web is made from bicomponent spunbond fibers. In these implementations, for example, the bicomponent fiber contains a polyethylene sheath and a polypropylene based elastomeric core, where the core (but not the sheath) may contain a secondary amide non-blocking additive, which can further improve the garment-like feel of the facing.

For example, in one aspect, the secondary amide additive is erucamide, oleamide, oleyl palmitamide, ethylene bis-oleamide, stearyl erucamide, or combinations thereof. Of course, it should be understood that, in one aspect, the secondary amide may be a non-fatty acid amide.

Regardless of the secondary amide selected, in one aspect, the secondary amide is present in the core in an amount of about 0.1% to about 10% by weight based upon the weight of the core, such as about 0.25% to about 5%, such as about 0.5% to about 2.5%, such as about 0.6% to about 1.5%, such as about 0.7% to about 1%, or any ranges or values therebetween. Particularly, the present disclosure has found that surprisingly, the secondary amide in the core provides improved spinnability and non-blocking properties to the bicomponent fiber, even when used in small amounts in the core.

Moreover, in one aspect, the sheath(s) is/are formed from one or more ethylene or propylene polymers, such as one or more generally non-elastomeric ethylene or propylene polymers. Thus, in one aspect, the non-elastomeric polyolefin may include generally inelastic polymers, such as conventional polyolefins, (e.g., polyethylene), low density polyethylene (LDPE), Ziegler-Natta catalyzed linear low density polyethylene (LLDPE), etc.), ultra low density polyethylene (ULDPE), polypropylene, polybutylene, etc.; polytetrafluoroethylene; polyesters, e.g., polyethylene terephthalate (PET), etc.; polyvinyl acetate; polyvinyl chloride acetate; polyvinyl butyral; acrylic resins, e.g., polyacrylate, polymethylacrylate, polymethylmethacrylate, etc.; polyamides, e.g., nylon; polyvinyl chloride; polyvinylidene chloride; polystyrene; polyvinyl alcohol; polyurethanes; polylactic acid; copolymers and mixtures thereof; and so forth. For instance, the sheath(s) can include an LLDPE available from Dow Chemical Co. of Midland, Mich., such as DOWLEX™ 2517 or DOWLEX™ 2047, or a combination thereof, or Westlake Chemical Corp. of Houston, Tex. Furthermore, in one aspect, the non-blocking polyolefin material may be other suitable ethylene polymers, such as those available from The Dow Chemical Company under the designations ASPUN™ (LLDPE) and ATTANE™ (ULDPE). available from The Dow Chemical Company under the designations DOWLEX™ (LLDPE), ASPUN™ (LLDPE), and ATTANE™ (ULDPE).

Further, in an aspect, the core is formed from a propylene polymer and/or copolymer. Thus, in one aspect, the core is formed from a propylene-based copolymer plastomers, such as a propylene-based copolymer commercially available under the designations VISTAMAXX™ (e.g., 2330, 6202, and 6102), a propylene-ethylene copolymer-based plastomer from ExxonMobil Chemical Co. of Houston, Texas; FINA™ (e.g., 8573) from Atofina Chemicals of Feluy, Belgium; TAFMER™ available from Mitsui Petrochemical Industries; and VERSIFY™ available from Dow Chemical Co. of Midland, Michigan. In addition to the above, the core can also contain a non-elastomeric olefin polymer, such as a metallocene catalyzed (single site catalyzed) polypropylene polymer in an amount of from about 1% by weight to about 40% by weight of the core, such as from about 2% by weight to about 5% by weight of the core.

Regardless of the elastomer(s) and non-elastomeric polyolefin selected, in one aspect the core is present in an amount of about 50% to about 97.5% by weight of the total weight of the elastomeric composition, such as about 60% to about 95%, such as about 70% to about 92.5%, such as about 80% to about 90%, such as about 82.5% to about 87.5% by weight of the total weight of the elastomeric composition, or any ranges or values therebetween.

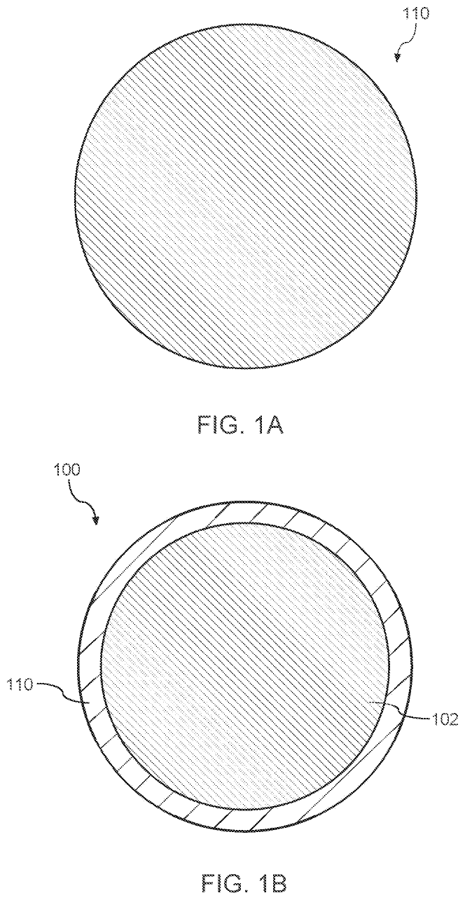

Referring to FIGS. 1A and 1B, respectively, a monocomponent fiber 12 and a bicomponent fiber 14 utilizing a sheath/core arrangement are shown. With respect to bicomponent fiber 14, the core 18 can be formed from a first polymer while the sheath 16 can be formed from a second polymer. Generally, the composition of the monocomponent fiber 12 or the core 18 of the bicomponent fiber can be chosen such that the resulting overall material is elastic, cloth-like, drapable, and soft, and the composition of the sheath 16 of the bicomponent fiber 14 can be chosen such that the sheath 16 provides some blocking properties, while not impacting the garment-like feel of the sheath 16. One such example bicomponent fiber suitable for use herein in the softness enhancing layer is described in U.S. Patent Application Ser. No. 63/003,427, filed on Apr. 1, 2020, entitled, “Elastic Bicomponent Fiber Having Unique Handfeel,” the entire contents of which are hereby incorporated by referenced including, without limitation, the composition of the claimed elastomeric bicomponent spunbond fiber and resulting nonwoven formed from that fiber.

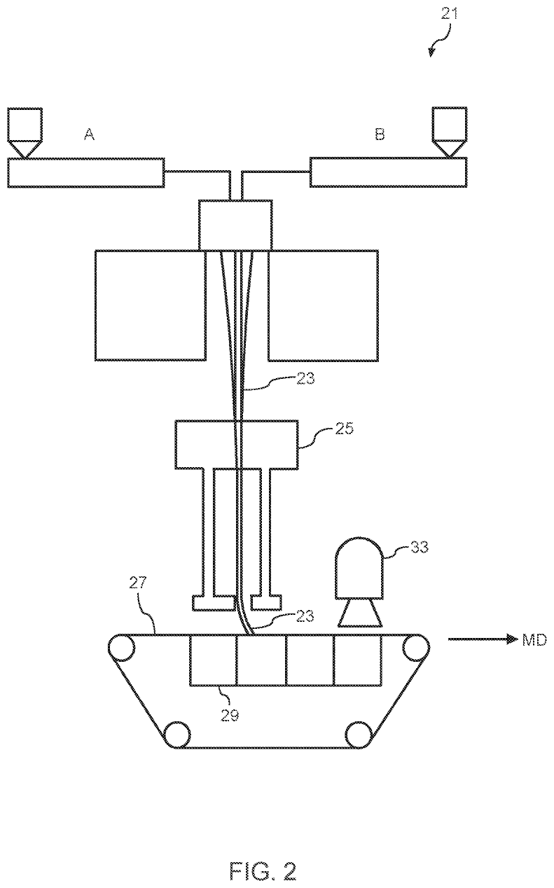

FIG. 2 shows an example process for forming elastomeric, monocomponent or bicomponent spunbond fibers. More specifically, the example process in FIG. 2 is configured to form substantially continuous fibers (e.g., to make an extensible or elastomeric layer 30). More particularly, in the case of a bicomponent fiber, different polymer compositions A (e.g., for the sheath) and B (for the core) are initially supplied to a fiber spinning apparatus 21 to form bicomponent fibers 23. Or, in the case of a monocomponent fiber, only one polymer type (e.g., which could include a blended polymer with or without additives) is supplied to a fiber spinning apparatus 21. Once formed, the fibers 23 are traversed through a fiber draw unit 25 and deposited on a moving forming wire 27. Deposition of the fibers is aided by an under-wire vacuum supplied by a suction box 29 that pulls down the fibers 23 onto the forming wire 27. The forming wire 27 is porous so that vertical air flow created by the suction box 29 can cause the fibers to lie down. In one aspect of the present disclosure, the flow rate of this air flow can be kept relatively low to enhance the tendency of the fibers 23 to remain oriented in the MD direction. Alternatively, the suction box 29 can contain sections that extend in the machine direction to disrupt the vertical air flow with at the point where the fibers are laid onto the moving web, thereby allowing the fibers to have a higher degree of orientation in the machine direction. One example of such a technique is described, for instance, in U.S. Pat. No. 6,331,268.

Of course, other techniques may also be employed to help fibers remain oriented in the machine direction. For example, deflector guide plates or other mechanical elements can be employed, such as described in U.S. Pat. Nos. 5,366,793 and 7,172,398. The direction of the air stream used to attenuate the fibers as they are formed can also be used to adjust to effect machine direction orientation, such as described in U.S. Pat. No. 6,524,521. Apart from process described above, other known techniques may also be employed to form the fibers. In one aspect, for example, the fibers may be quenched after they are formed and then directly deposited onto a forming wire without first being drawn in the manner described above. In such aspects, as described above, the flow rate of this air flow can be kept relatively low to enhance the tendency of the fibers to remain oriented in the MD direction, however, it should be understood that, in one aspect, the fibers are not oriented in primarily the MD direction.

Referring again to FIG. 2, once the fibers 23 are formed, they may be heated by a diffuser 33, which can blow hot air onto the surface of the fibers to lightly bond them together for further processing. A hot air knife may also be employed as an alternative to the diffuser. Other techniques for providing integrity to the web may also be employed, such heated calender rolls. In any event, the resulting fibers may then be bonded to form a consolidated, coherent nonwoven web structure, for example, to create the elastomeric facing of the present disclosure. Any suitable bonding technique may generally be employed in the present disclosure, such as adhesive or autogenous bonding (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with polymer composition used to form the fibers. Suitable autogenous bonding techniques may include ultrasonic bonding, thermal bonding, through-air bonding, and so forth. Thermal point bonding, for instance, typically employs a nip formed between two rolls, at least one of which is patterned. Ultrasonic bonding, on the other hand, typically employs a nip formed between a sonic horn and a patterned roll. Although the above describes in detail the use of bicomponent fibers, extensible or elastomeric monocomponent fibers can also be used to create the fibers for the nonwoven web material (e.g., facing).

The spunbond web may also be subjected to one or more additional post-treatment steps. For example, the spunbond web may be stretched in the cross-machine direction using known techniques, such as tenter frame stretching, groove roll stretching, etc. The spunbond web may also be subjected to other known processing steps, such as aperturing, heat treatments, etc.

### Strength-Building Layer

As described above, nonwoven materials made in accordance with the present disclosure include at least one softness enhancing layer as described above in combination with at least one strength-building layer. The strength-building layer can be directly attached to the softness enhancing layer or can be separated from the softness enhancing layer by other layers.

The strength-building layer can be formed from continuous filaments or fibers and can also comprise a spunbond nonwoven web. The fibers can be formed from a non-elastomeric polymer, such as a polyolefin. Suitable polyolefins include, but are not limited to, homopolymers, copolymers and terpolymers of ethylene (e.g., low density polyethylene, high density polyethylene, linear low density polyethylene, etc.), propylene (e.g., syndiotactic, atactic, isotactic, etc.), butylene and so forth. In addition, blends and combinations of the foregoing are also suitable for use in connection with the present invention. In one embodiment, for instance, the polymeric portion of the polymer composition will include greater than about 65 weight percent olyolefin polymer(s) and in certain embodiments the polymer may comprise at least about 65, 70, 75, 80, 85, 90, 95% by wt. olefin polymer and/or less than about 100, 99, 98 or 97 wt. % olefin polymer. Further, in a particular embodiment, the polymeric portion of the polymer composition may comprise entirely of olefin polymers such as for example, comprising entirely of polymers selected from the group of propylene, ethylene and butylene polymers. The polymer composition will have a melt-flow rate (MFR) less than about 60 dg/minute, and in certain embodiments will have an MFR greater than about 5, 8, 10, 12 or 15 dg/minute and/or less than about 55, 53, 50, 48 or 45 dg/minute. Further, as is known in the art, the polymer composition may optionally include one or more fillers, colorants (e.g. TiO₂, pigments), antioxidants, softening agents, surfactants, slip agents and so forth. In particular, as is well known in the art, one or more slip agents, such as fatty acid amides, may be added to the polymer composition for melt spinning.

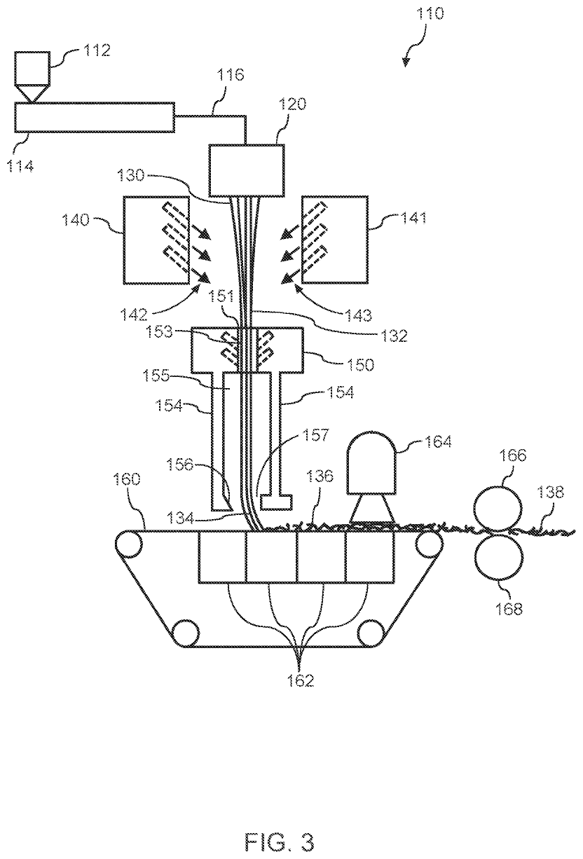

In one aspect, the strength-building layer is formed from non-elastomeric fibers that have a relatively small size. For instance, the fibers can have a denier of less than about 2, such as less than about 1.5. Referring to FIG. 3, for instance, one embodiment of a process and system 110 for producing strength-building layers is shown.

In one embodiment, the polymer composition (not shown), typically in the form of pellets, is provided in a hopper 112 and fed into an extruder 114 which melts the polymeric portion of the composition and forms an initial stream of molten polymer. The molten polymer stream is pumped to the spinning assembly 120 via piping 116. While suitable ranges will vary with particular polymers, generally speaking, in order to limit degradation or other undesired effects on the polymers, the molten polymer typically is not heated to a temperature more than about 150° C., 125° C., 100° C. or 85° C. of the melting point. In certain embodiments the polymer may be heated to a temperature between about 30° C. and about 150° C. or between about 45° C. and about 125° C. above of its melting point.

The spinning assembly 120 can include various components. For instance, the spinning assembly 120 can include a distributor, a filter or screen, a support plate, and a spinneret that are positioned in the direction of flow within the spinning assembly 120. The molten stream of polymer fed to the distributor, for instance, can spread the molten polymer across a broader area by directing the molten polymer stream laterally and downwardly towards the spinneret. The screen or filter serves to filter impurities or other unwanted debris from the molten streams in order to prevent fouling of the spinneret. Suitable screens may, for example, comprise one or more stacked screens ranging between about 50 to about 350 mesh.

In one aspect, the spinneret includes a pattern of conduits extending through the thickness of the spinneret wherein the molten polymer flows through inlet openings and from there through associated inlet channels or counterbores. The molten polymer then enters capillaries that exit through an orifice. Each capillary, for instance, can have the same diameter as the exit orifice. In one embodiment, the portion of the conduit above the capillary (e.g. upstream) can have a significantly larger diameter than that of the capillary. For instance, the portion of the conduit above the capillary can have a diameter that is at least about 250%, such as at least about 350%, such as at least about 450% larger than the capillary diameter.

The size of the exit orifices and capillary can vary such as for example having a diameter between about 0.2 mm and about 0.45 mm. In certain embodiments, the exit orifice and/or capillary can have a diameter of at least 0.2 mm, 0.23 mm, 0.25 mm, 0.28 mm or 0.29 mm and/or a diameter less than about 0.45 mm, 0.42 mm, and 0.40 mm, 0.39 mm or 0.38 mm. As used herein the diameter, for non-circular orifices, is determined across the longest diameter line of the opening. The length of the capillary (L) extends proportional to the diameter (D) of the exit orifice and the length of the capillary divided by orifice diameter (L/D) will be at least about 4. In certain embodiments, the L/D may be equal to or greater than about 4.0, 4.3, 4.5, 4.7, 5.0, 5.3, 5.5, 5.7, 6.0, 6.3 or 6.5 and/or the L/D may be less than about 10.5, 10.0, 9.7, 9.5, 9.3, 9.0, 8.7, 8.5, 8.3 or 8.0. By way of example, the L/D ratio can be between about 4 and about 10, between about 5 and about 10, between about 6 and about 10, between about 5 and about 9, between about 6 and about 9, or even between about 6 and about 8.

The pattern of conduits, capillaries, and orifices in the spinneret can vary depending upon the particular application. The spinneret, for instance, can include a series of rows extending in parallel. In certain embodiments the inner or center region of the extrusion area may have less closely spaced exit orifices as compared to regions adjacent the CD edges, proximate the quench air flow. In this regard, the pattern of exit orifices may have a CD extending segment at or proximate the center of the extrusion area that has reduced density of conduits or that is entirely lacking exit orifices. For example, the center region may have a section extending across the CD centerline having an MD width between about 10 and about 60 mm that either lacks any conduits or alternatively that has a significantly reduced capillary density (e.g. a capillary density less than 70%, 60%, 50%, 40% or 30% of the average).

The spinneret can have a relatively high density or close spacing of exit orifices such as for example those having an exit orifice or hole density at least about 3 exit orifices per cm²; the density being measured in relation to the number of exit orifices within the extrusion area. In certain embodiments the spinneret may have an exit orifice density at least about 3.5, 3.7, 4, 4.3, 4.5, 4.7, 5, 5.3, 5.5, 5.7, 6, 6.5, 6.7, 7, 7.3 or 7.5 exit orifices per cm² and/or no more than about 20, 19.5, 19, 18.7, 18.5, 18.3, 18, 17.7, 17.5, 17.3, 17, 16.7, 16.5, 16.3, 16, 15.7, 15.5, 15.3, 15, 14.7, 14.5, 14.3 or 14 exit orifices per cm². In a further aspect, the number of exit orifices within the spinneret will be greater than 5000 per meter of the extrusion area length (CD length) and in certain embodiments will be greater than about 6000/M, 6500/M, 7000/M, 7500/M, 8000/M or even 8500/M per meter of the extrusion area length (CD length).

The molten polymer is pumped into and through the spinning assembly and spinneret at high-pressures to achieve the throughputs and exit velocities discussed herein below. The molten polymer is extruded out of the exit orifices at rates of at least about 0.3 g/hole/minute or “g/h/m.” To calculate g/h/m, the mass of the extrudate composition pumped through the spinneret over a selected period of time is divided by the number of exit orifices and the selected time. The extrusion rate, in certain embodiments, may be at least about 0.3 g/h/m, 0.33 g/h/m, 0.35 g/h/m, 0.37 g/h/m, 0.4 g/h/m, 0.43 g/h/m or 0.45 g/h/m and/or not more than about 0.6 g/h/m, 0.57 g/h/m, 0.55 g/h/m, 0.53 g/h/m or 0.5 g/h/m. In a further aspect, the molten extrudate is pumped through and out of the spinneret having an exit velocity greater than about 10 feet/minute and in certain embodiments may be at least about 10.3, 10.5, 10.7, 11, 11.3, 11.5, 11.7, 12, 12.3 or 12.5 feet/minute and/or may be not more than about 45, 43, 40, 38, 35, 33, 30, 28, 25 or 23 feet/minute. The exit velocity (Vₑ) of the extrudate at the exit orifices is calculated according to the formula below:

$${V}_{e} = \frac{{M}_{f / E}}{ρ A}$$

M_{f}=the mass flow rate of the extrudate (lb./min.)
E=the number of exit orifices
ρ=density of molten extrudate (lb./ft³)
A=the cumulative cross-sectional area of the exit orifices (ft²)

In a further aspect, the temperature of the polymer can be regionally controlled either as it enters the spinning assembly or as it moves through the spinning assembly such that the temperature of the molten polymer extrudate exiting the exit openings proximate the quench air is at a higher temperature relative to the molten polymer extrudate exiting the exit openings within the interior of the spinneret and extrusion region. In reference to the embodiments described herein, molten polymer at a first temperature would be extruded out of the rows of exit openings proximate the CD edge and molten polymer at a second temperature (lower than the first temperature) would be extruded out of rows of exit openings proximate the center of the spinneret and spinning area. In this regard, the quench air will first impact and pass through the outer portions of the bundle and as it does so and cools the molten filaments the quench air will warm prior to striking the inner or centrally located filaments within the bundle. When the outer extruded filaments are at a slightly elevated temperature relative to the inner extruded filaments, this will help improve processing at the conditions described herein and create a more uniform frost line across the total filament bundle.

As the molten polymer composition is extruded out of the orifices of the spinneret, a bundle of molten strands is formed traveling downwardly and away from the spinneret. Immediately below the lower surface of the spinneret are blowers 140 and 141 which direct cooling or quench air 142 and 143 into the bundle in order to at least partially solidify the molten strands 130.

Various different quench air systems are known in the art and may be used in connection with the present invention. The quench air may be provided from a single blower at a single temperature or may be provided from multiple blowers at different temperatures. For example, a quench system may include a stack of multiple quench air blowers on one or both sides of the bundle, wherein the upper air boxes provide air at different temperatures relative to that provided by quench air boxes located thereunder. The quench air temperature will vary in relation to the properties of the polymers being melt-spun, the extrusion temperature, quench air speed, the filament speed, filament density, and other factors as is known in the art. Generally speaking, quench air is provided at temperatures between about 5-60° C. or about 5-35° C. In addition, the quench air may be provided at speeds between about 30-120 M/minute. Typically the quench air is introduced into the filament bundle at an angle perpendicular to or substantially perpendicular to the direction of the filament flow. However, the quench air may alternatively be directed into the molten filaments at an angle, relative the direction of the filament flow, that is slightly acute or obtuse (i.e. may be directed slightly upwardly or downwardly).

As may be seen in FIG. 3, the quenched, solidified or substantially solidified filaments 132 are then fed into a filament drawing unit 150 which acts to further attenuate or reduce the diameter of the filaments 130, 132. The filament draw unit 150 has at least two walls 154 defining channels 153,155 through which high speed air pneumatically draws the filaments 132 downwardly away from the spinneret 124 and towards the forming wire 160. The quenched filaments 132 initially enter the constricted intake opening 151 and are directed through an upper narrow channel 153. The constricted opening is typically one having an MD width that is not more than about 25% of the MD width of the extrusion area. In certain embodiments the constricted opening may have an MD width that is not more than about 20%, 18%, 15%, 12% or 10% of the MD width of the extrusion area and/or an MD width that is not less than about 0.5%, 1%, 2% or 3% of the MD width of the extrusion area. The CD width of the constricted opening may be about the same as the CD length of the extrusion area and in certain embodiments may have a CD length at least about 1%, 2%, 4% or 5% longer than the CD length of the extrusion area. The quenched filaments and the quench air will together enter the constricted opening.

Additional high speed air or draw air may also directed into the fiber draw unit such as being directed into the upper narrow channel 153 via conduits and blowers in fluid communication therewith. In addition, the draw air introduced into the channel(s) of the drawing unit may be introduced at speeds greater than about 50 M/second or 75 M/second. The draw air may be directed into the channel(s) from either one or more sides of the draw unit and at one or more locations vertically within the draw unit. The angle of introduction may be either perpendicular to the direction of the filament flow or at a downward angle.

The fiber draw unit may have additional channels below the initial constricting opening and associated channel. The additional channels below the initial constricted opening and associated channel may be sequentially smaller, wider than the constricted opening or have sections of varying MD width. In reference to the embodiment depicted in FIG. 3, the lower channel 155 is wider than the narrow upper channel 153 associated with the constricted opening 151. The filaments are drawn through the second lower channel 155 and then out of the draw unit 150 through the exit opening 157. In the embodiment shown, the speed of the air rushing downwardly through the draw unit pulls the fibers downwardly away from the spinneret and towards the forming surface. This downward force on the continuous filaments applies a corresponding drawing or pulling force that is transmitted along the quenched filaments and extruded molten filaments. In closed systems, the pressure differential is also a primary driver of the drawing air and filaments. Adequate drawing distance is required in order to sufficiently draw down the fibers. In this regard, the distance between the bottom surface of the spinneret to the convergence of the bundle at a constricted channel opening above the drawing portion is at least about 90 cm and in certain embodiments may be between about 90 cm and about 300 cm or even between about 100 and about 230 cm. In relation to the embodiment shown in FIG. 3, the drawing distance extends from the bottom surface 190 of the spinneret 124 to the inlet opening 151 of the narrow channel 153 atop of the fiber draw unit 150.

The pneumatic forces acting upon the filaments are configured to achieve a draw ratio of not more than about 1100 and in certain embodiments may be at least about 250, 280, 300, 330, 350, 380, 400, 430, 450, 480, 500, 530, 550, 580, 600, 630 or 650 and/or not more than about 1100, 1080, 1050, 1030, 1000, 980 or 950. The draw ratio is calculated by dividing the terminal velocity (VT) by the exit velocity (V_{E} discussed above) as follows:

$$Draw Ratio = \frac{{V}_{T}}{{V}_{E}}$$

The terminal velocity is calculated as follows:

$${V}_{T} = \frac{{V}_{E} \times {A}_{E}}{{A}_{T}}$$

where:
V_{E}=initial velocity as discussed herein above
A_{E}=the cross-sectional area of diameter of the exit orifice
Aᵣ=the cross-sectional area of the resulting filament

The entraining air forming the pneumatic forces upon the filaments enters the system from the openings or gaps located between the various components above the drawing unit and the various blowers as noted. However, the filament draw unit will typically employ additional air blowers or other air feeds as is known in the art. The walls 154 of the draw unit 150 may optionally be manipulated inwardly or outwardly in order to modify the size of the channel at different locations within the draw unit. In certain embodiments, the walls 154 may be moved inwardly or outwardly in discrete sections so as to form a channel having varying dimension or widths in order to adjust the drawings forces and spreading of the filaments within the bundle. Still further, in order to improve the uniform spreading and coverage of the formed nonwoven fabric, as is known in the art a deflector plate 156 may be used to spread the filaments. Optionally, electrostatic charge bars (not shown) or other components may further be employed to aid with spreading of filaments, web formation and laydown. While the drawings depict an open air melt-spinning system, it will be readily appreciated that the process of the present invention will also work with closed-air systems as are known in the art. Examples of various quench and drawings systems suitable for use in the present invention include, but are not limited to, those described in U.S. Pat. No. 4,340,563 to Appel et al, U.S. Pat. No. 5,935,512 to Haynes et al., U.S. Pat. No. 6,692,601 Najour et al., U.S. Pat. No. 6,783,722 to Taylor, U.S. Pat. No. 7,037,097 Wilkie et al., U.S. Pat. No. 7,762,800 to Geus et al., U.S. Pat. No. 8,246,898 to Conrad et al., U.S. Pat. No. 8,333,918 to Lennon et al. and US2017/0211217 Nitschke et al.

The fully drawn filaments 134 exit the bottom of the filament drawing unit 150 through the exit opening 157 and are deposited onto a forming surface 160 such as a fabric or wire. As is known in the art, one or more vacuums 162 are positioned beneath the forming surface 160 to draw the filaments on to the forming surface 160 and form a relatively loose matt or web 136 of filaments 134. The vacuums also remove the draw air in order to prevent deflected air from interfering with filament lay-down and/or from disturbing the matt 136 once laid on the wire. The suctioning of the air from underneath the drawing unit can also assist in driving the movement of both the air and fibers through the drawing unit and onto the forming wire.

Optionally, the matt of filaments can be treated in order to impart some minimal degree of integrity required for additional handling. Such treatment may, for example, include consolidating the matt with a compaction roll (not shown) or through the use of a high velocity through-air bonder 164. Such through-air bonders impart only minimal filament-to-filament bonding sufficient for additional handling and processing and without significantly melting the filaments. Such bonders and methods are described in U.S. Pat. No. 5,707,468 to Arnold et al. In addition, in order to achieve relatively higher basis weight fabrics, multiple banks of spinnerets and drawing units may be located sequential over the foraminous forming surface upstream of the consolidating and/or bonding apparatus.

After formation, the nonwoven matt is desirably bonded in order to increase the overall integrity and strength of the same. In one aspect, the matt may be mechanically bonded such as by entanglement. In this regard, the filaments may be entangled by hydroentangling which includes subjecting the matt to one or more rows of fine high-pressure jets of water so that the filaments become sufficiently entangled with one another to form a coherent nonwoven fabric. In other embodiments, the matt may be bonded by one or more techniques known in the art such as by the application of adhesive, pressure, heat and/or ultrasonic energy. In certain aspects, the matt may be pattern bonded, as is known in the art, using a pair of bonding rolls 166, 168, wherein at least one of the rolls has a pattern of protuberances or “pins” corresponding to the desired pattern of bond points to be imparted to the matt and form a bonded nonwoven fabric 138. The two cooperative rolls form a nip through which the matt is passed with the application of pressure and, optionally, heat. While suitable bond elements may be formed without the application of heat, use of heat together with pressure is preferred. The bonding can be conducted as is known in the art employing a nip formed by patterned roll and a smooth anvil roll (“pin-to-flat”) or by two coordinated patterned rolls (“pin-to-pin”). With respect to the use of a smooth anvil roll, the roll may be a steel roll or alternatively may be coated with a resilient material. By way of example only, various pattern bonding methods are shown and described in U.S. Pat. No. 3,855,046 to Hansen et al., U.S. Pat. No. 4,333,979 to Sciaraffa et al., U.S. Pat. No. 4,374,888 to Bornslaeger, U.S. Pat. No. 5,110,403 to Ehlert, U.S. Pat. No. 5,858,515 to Stokes et al., U.S. Pat. No. 6,165,298 to Samida et al. and so forth. As is known in the art, the pressures, temperatures, residence time, base sheet composition, basis weight, and other parameters will impact the selection of the desired degree of pressure and/or heat applied to the base sheet to form the bond points. Alternatively, the matt of filaments can be adhesively bonded such by spray, gravure roll or other means for the application of adhesive in the desired pattern as is known in the art.

The resulting nonwoven fabric desirably has high tensile strength, uniform opacity (coverage) and/or pleasing hand. For many applications the bonded nonwoven fabric can have a basis weight less than about 175 g/m². In certain embodiments, the nonwoven fabrics can have a basis weight less than about 150 g/m², 120 g/m², 90 g/m², 60 g/m², 45 g/m², 35 g/m², 30 g/m², 25 g/m², 20 g/m², 18 g/m², 16 g/m², 14 g/m², 12 g/m², 10 g/m², 9 g/m², 8 g/m², 7 g/m², and further, in certain embodiments, can have a basis weight in excess of about 4 g/m², 5 g/m², 7 g/m² or 10 g/m². Further, the filaments as formed by this process and as provided in the corresponding nonwoven fabric can have an average denier (g/9000M) of less than about 1.5 or less and in certain embodiments may have an average fiber denier equal to or less than about 1.4, 1.3 or 1.2 and/or at least about 0.7, 0.73, 0.75, 0.77, 0.8, 0.83, 0.85, 0.87 or 0.9. Similarly, the filaments as formed by this process and as provided in the corresponding nonwoven fabric can have an average fiber size less than or equal to about 16 microns and in certain embodiments may have an average fiber size equal to or less than about 16, 15.8, 15.5, 15.3, 15, 14.8 or 14.5 microns and/or at least about 10, 10.3, 10.5, 10.8, 11, 11.3, 11.5, 11.8 or 12 microns.

### Multi-Layer Nonwoven Material

In accordance with the present disclosure, at least one strength-building layer is combined with at least one softness enhancing layer in order to produce a multi-purpose nonwoven material. In general, the strength-enhancing layer forms an exterior top surface of the nonwoven material. The strength-building layer, on the other hand, can form the bottom layer or a middle layer of the material. The strength-building layer and the softness enhancing layer can be produced as shown in FIGS. 2 and 3 and then later brought together to form a multi-layer nonwoven web. The two layers can be attached together using any suitable bonding process including thermal bonding, adhesive bonding, ultrasonic bonding, or the like.

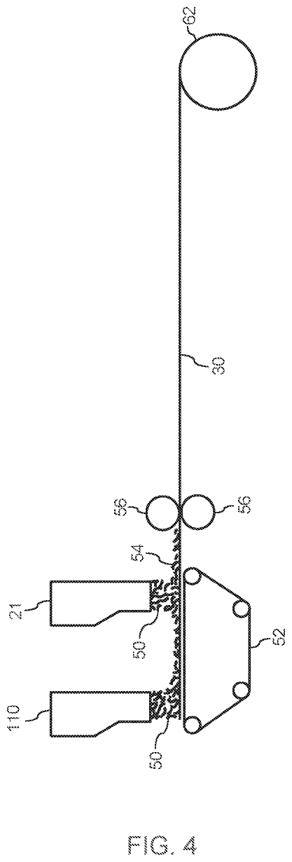

Alternatively, as shown in FIG. 4, a two-bank melt spinning system and process as shown in FIG. 4 can be used to produce the nonwoven material. As shown in FIG. 4, for instance, the process for producing the nonwoven material includes the system 110 for producing strength-building layers and a system 21 for producing softness enhancing layers. The systems include spun bond extruders 110 and 21 that produce fibers 50 that are then deposited onto a forming wire 52. If desired, a vacuum may be utilized to maintain the fibers on the forming wire 52. The spun bond fibers 50 produce a softness enhancing layer on top of a strength-building layer to produce a web 54. The web 54 may be optionally compressed by a compaction roll 56. As shown, a multi-layer nonwoven material 30 is produced that is then wound into a roll 62.

In the embodiment illustrated in FIG. 4, a two-layer nonwoven material 30 is produced. It should be understood, however, that further extruders can be placed in line for producing nonwoven materials having more than two layers. The additional layers can be further strength building layers, further softness enhancing layers, or other layers as may be desired. For example, the nonwoven material can contain from about 2 to about 10 strength building layers (including all increments of one strength building layer therebetween) and the nonwoven material can contain from about 2 to about 10 softness enhancing layers (including all increments of one softness enhancing layer therebetween). In one aspect, the nonwoven material contains about 3 to about 8 layers including 1, 2, 3, 4, 5, or 6 strength building layers and the remainder softness enhancing layers. In another aspect, the nonwoven material contains 4 layers including 1, 2, or 3 strength building layers and the remainder softness enhancing layers.

The nonwoven materials made in accordance with the present disclosure can be used in numerous and diverse applications. For example, the nonwoven material can be used in an absorbent article. An absorbent article refers to any article capable of absorbing water or other fluids. Examples of some absorbent articles include, but are not limited to, personal care absorbent articles, such as diapers, training pants, absorbent underpants, incontinence articles, feminine hygiene products, swimwear, baby wipes, and the like; medical absorbent articles such as garments, fenestration materials, underpads, bed pads, bandages, absorbent drapes, and medical wipes; food surface wipers; clothing articles; and so forth.

The nonwoven material 30 made in accordance with the present disclosure can generally have a basis weight of from about 5 gsm to about 300 gsm, including all increments of 1 gsm therebetween. In one embodiment, the basis weight can be from about 5 gsm to about 170 gsm. Of particular advantage, very lightweight materials can be produced according to the present disclosure that have a significant amount of strength in combination with excellent softness properties. For instance, the above properties can be obtained at basis weights of less than about 30 gsm, such as less than about 25 gsm, such as less than about 20 gsm, such as less than about 18 gsm, and at basis weights of generally greater than about 7 gsm, such as greater than about 9 gsm, such as greater than about 11 gsm, such as greater than about 13 gsm.

The weight ratio between the strength-building layer(s) and the softness enhancing layer(s) can also vary depending upon the particular application. In one embodiment, the softness enhancing layer can have a greater basis weight than the strength-building layer. Alternatively, the strength-building layer can have a higher basis weight than the softness enhancing layer. In one embodiment, the weight ratio between the strength-building layer and the softness enhancing layer is from about 1:5 to about 5:1, such as from about 1:4 to about 4:1, such as from about 1:3 to about 3:1, such as from about 1:2 to about 2:1, such as from about 1:3 to about 1.5:1, such as from about 1:2 to about 1.1:1.

### Elastic Laminate

In one embodiment, the nonwoven material of the present disclosure can be incorporated into an elastic laminate. The nonwoven material, for instance, can be attached to an elastic backing. The elastic backing can be a film or can comprise a plurality of parallel filaments, such as ribbons.

In some implementations, the elastic film (e.g., film) is formed from one or more elastomeric polymers that are melt-processable, i.e., thermoplastic. Any of a variety of thermoplastic elastomeric polymers may generally be used including, for example, elastomeric polyesters, elastomeric polyurethanes, elastomeric polyamides, elastomeric copolymers, elastomeric polyolefins, and so forth. In some implementations involving aperturing the film, elastomeric semi-crystalline polyolefins are used due to their unique combination of mechanical and elastomeric properties. That is, the mechanical properties of such semi-crystalline polyolefins allows for the formation of films that readily aperture during thermal bonding, but yet retain their elasticity.

Semi-crystalline polyolefins have or are capable of exhibiting a substantially regular structure. For example, semi-crystalline polyolefins may be substantially amorphous in their undeformed state, but form crystalline domains upon stretching. The degree of crystallinity of the olefin polymer may be from about 3% to about 30%, in some embodiments from about 5% to about 25%, and in some embodiments, from about 5% and about 15%. Likewise, the semi-crystalline polyolefin may have a latent heat of fusion (ΔHf), which is another indicator of the degree of crystallinity, of from about 15 to about 75 Joules per gram (“J/g”), in some embodiments from about 20 to about 65 J/g, and in some embodiments, from 25 to about 50 J/g. The semi-crystalline polyolefin may also have a Vicat softening temperature of from about 10° C. to about 100° C., in some embodiments from about 20° C. to about 80° C., and in some embodiments, from about 30° C. to about 60° C. The semi-crystalline polyolefin may have a melting temperature of from about 20° C. to about 120° C., in some embodiments from about 35° C. to about 90° C., and in some embodiments, from about 40° C. to about 80° C. The latent heat of fusion (ΔHf) and melting temperature may be determined using differential scanning calorimetry (“DSC”) in accordance with ASTM D-3417 as is well known to those skilled in the art. The Vicat softening temperature may be determined in accordance with ASTM D-1525.

Exemplary semi-crystalline polyolefins include polyethylene, polypropylene, blends and copolymers thereof. In one particular embodiment, a polyethylene is employed that is a copolymer of ethylene and an α-olefin, such as a C3-C20 α-olefin or C3-C12 α-olefin. Suitable α-olefins may be linear or branched (e.g., one or more C1-C3 alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

The density of the polyethylene may vary depending on the type of polymer employed, but generally ranges from 0.85 to 0.96 grams per cubic centimeter (“g/cm3”). Polyethylene “plastomers”, for instance, may have a density in the range of from 0.85 to 0.91 g/cm3. Likewise, “linear low density polyethylene” (“LLDPE”) may have a density in the range of from 0.91 to 0.940 g/cm3; “low density polyethylene” (“LDPE”) may have a density in the range of from 0.910 to 0.940 g/cm3; and “high density polyethylene” (“HDPE”) may have density in the range of from 0.940 to 0.960 g/cm3. Densities may be measured in accordance with ASTM 1505.

Example polyethylene copolymers include those that are “linear” or “substantially linear.” The term “substantially linear” means that, in addition to the short chain branches attributable to comonomer incorporation, the ethylene polymer also contains long chain branches in that the polymer backbone. “Long chain branching” refers to a chain length of at least 6 carbons. Each long chain branch may have the same comonomer distribution as the polymer backbone and be as long as the polymer backbone to which it is attached. Preferred substantially linear polymers are substituted with from 0.01 long chain branch per 1000 carbons to 1 long chain branch per 1000 carbons, and in some implementations, from 0.05 long chain branch per 1000 carbons to 1 long chain branch per 1000 carbons. In contrast to the term “substantially linear”, the term “linear” means that the polymer lacks measurable or demonstrable long chain branches. That is, the polymer is substituted with an average of less than 0.01 long chain branch per 1000 carbons.

Example plastomers for use in forming the film include ethylene-based copolymer plastomers available under the designation EXACT™ from ExxonMobil Chemical Company of Houston, Tex. Other suitable polyethylene plastomers are available under the designation ENGAGE™ and AFFINITY™ from Dow Chemical Company of Midland, Mich. Still other suitable ethylene polymers are available from The Dow Chemical Company under the designations DOWLEX™ (LLDPE) and ATTANE™ (ULDPE). Other suitable ethylene polymers are described in U.S. Pat. No. 4,937,299 to Ewen et al.; U.S. Pat. No. 5,218,071 to Tsutsui et al.; U.S. Pat. No. 5,272,236 to Lai. et al.; and U.S. Pat. No. 5,278,272 to Lai, et al., which are incorporated herein in their entirety by reference thereto for all purposes.

Other polymers, for example, propylene polymers may also be suitable for use as a semi-crystalline polyolefin. Suitable plastomeric propylene polymers may include, for instance, copolymers or terpolymers of propylene include copolymers of propylene with an α-olefin (e.g., C3-C20), such as ethylene, 1-butene, 2-butene, the various pentene isomers, 1-hexene, 1-octene, 1-nonene, 1-decene, 1-unidecene, 1-dodecene, 4-methyl-1-pentene, 4-methyl-1-hexene, 5-methyl-1-hexene, vinylcyclohexene, styrene, etc. The comonomer content of the propylene polymer may be about 35 wt. % or less, in some implementations from about 1 wt. % to about 20 wt. %, and in some embodiments, from about 2 wt. % to about 10 wt. %. Preferably, the density of the polypropylene (e.g., propylene/α-olefin copolymer) may be 0.91 grams per cubic centimeter (g/cm3) or less, in some embodiments, from 0.85 to 0.88 g/cm3, and in some implementations, from 0.85 g/cm3 to 0.87 g/cm3. Suitable propylene polymers are commercially available under the designations VISTAMAXX™ from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Other examples of suitable propylene polymers are described in U.S. Pat. No. 6,500,563 to Datta. et al.; U.S. Pat. No. 5,539,056 to Yang, et al.; and U.S. Pat. No. 5,596,052 to Resconi, et al., which are incorporated herein in their entirety by reference thereto for all purposes.

Any of a variety of known techniques may generally be employed to form the semi-crystalline polyolefins. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. No. 5,571,619 to McAlpin et al.; U.S. Pat. No. 5,322,728 to Davis et al.; U.S. Pat. No. 5,472,775 to Obijeski et al.; U.S. Pat. No. 5,272,236 to Lai et al.; and U.S. Pat. No. 6,090,325 to Wheat, et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (Mw/Mn) of below 4, controlled short chain branching distribution, and controlled isotacticity.

The melt flow index (MI) of the semi-crystalline polyolefins may generally vary, but is typically in the range of about 0.1 grams per 10 minutes to about 100 grams per 10 minutes, in some embodiments from about 0.5 grams per 10 minutes to about 30 grams per 10 minutes, and in some embodiments, about 1 to about 10 grams per 10 minutes, determined at 190° C. The melt flow index is the weight of the polymer (in grams) that may be forced through an extrusion rheometer orifice (0.0825-inch diameter) when/subjected to a force of 5000 grams in 10 minutes at 190° C., and may be determined in accordance with ASTM Test Method D1238-E.

Of course, other thermoplastic polymers may also be used to form the elastic film, either alone or in conjunction with the semi-crystalline polyolefins. For instance, a substantially amorphous block copolymer may be employed that has at least two blocks of a monoalkenyl arene polymer separated by at least one block of a saturated conjugated diene polymer. The monoalkenyl arene blocks may include styrene and its analogues and homologues, such as o-methyl styrene; p-methyl styrene; p-tert-butyl styrene; 1,3 dimethyl styrene p-methyl styrene; etc., as well as other monoalkenyl polycyclic aromatic compounds, such as vinyl naphthalene; vinyl anthrycene; and so forth. Preferred monoalkenyl arenes are styrene and p-methyl styrene. The conjugated diene blocks may include homopolymers of conjugated diene monomers, copolymers of two or more conjugated dienes, and copolymers of one or more of the dienes with another monomer in which the blocks are predominantly conjugated diene units. Preferably, the conjugated dienes contain from 4 to 8 carbon atoms, such as 1,3 butadiene (butadiene); 2-methyl-1,3 butadiene; isoprene; 2,3 dimethyl-1,3 butadiene; 1,3 pentadiene (piperylene); 1,3 hexadiene; and so forth.

Example thermoplastic elastomeric copolymers are available from Kraton Polymers LLC of Houston, Tex. under the trade name KRATON®. KRATONO polymers include styrene-diene block copolymers, such as styrene-butadiene, styrene-isoprene, styrene-butadiene-styrene, and styrene-isoprene-styrene. KRATON® polymers also include styrene-olefin block copolymers formed by selective hydrogenation of styrene-diene block copolymers. Examples of such styrene-olefin block copolymers include styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene. These block copolymers may have a linear, radial or star-shaped molecular configuration. Specific KRATON® block copolymers include those sold under the brand names G 1652, G 1657, G 1730, MD6673, and MD6973. Various suitable styrenic block copolymers are described in U.S. Pat. Nos. 4,663,220, 4,323,534, 4,834,738, 5,093,422 and 5,304,599, which are hereby incorporated in their entirety by reference thereto for all purposes. Other commercially available block copolymers include the S-EP-S elastomeric copolymers available from Kuraray Company, Ltd. of Okayama, Japan, under the trade designation SEPTON®. Still other suitable copolymers include the S-I-S and S-B-S elastomeric copolymers available from Dexco Polymers of Houston, Tex. under the trade designation VECTOR®. Also suitable are polymers composed of an A-B-A-B tetrablock copolymer, such as discussed in U.S. Pat. No. 5,332,613 to Taylor, et al., which is incorporated herein in its entirety by reference thereto for all purposes. An example of such a tetrablock copolymer is a styrene-poly(ethylene-propylene)-styrene-poly(ethylene-propylene) (“S-EP-S-EP”) block copolymer.

The amount of elastomeric polymer(s) employed in the film may vary, but is typically about 30 wt. % or more of the film, in some embodiments about 50 wt. % or more, and in some embodiments, about 80 wt. % or more of the of the film. In one embodiment, for example, the semi-crystalline polyolefin(s) constitute about 70 wt. % or more of the film, in some embodiments about 80 wt. % or more of the film, and in some embodiments, about 90 wt. % or more of the film. In other embodiments, blends of semi-crystalline polyolefin(s) and elastomeric block copolymer(s) may be employed. In such embodiments, the block copolymer(s) may constitute from about 5 wt. % to about 50 wt. %, in some embodiments from about 10 wt. % to about 40 wt. %, and in some embodiments, from about 15 wt. % to about 35 wt. % of the blend. Likewise, the semi-crystalline polyolefin(s) may constitute from about 50 wt. % to about 95 wt. %, in some embodiments from about 60 wt. % to about 90 wt. %, and in some embodiments, from about 65 wt. % to about 85 wt. % of the blend. It should of course be understood that other elastomeric and/or non-elastomeric polymers may also be employed in the film.

Besides polymers, the elastic film may also contain other components as is known in the art. In one embodiment, for example, the elastic film contains a filler. Fillers are particulates or other forms of material that may be added to the film polymer extrusion blend and that will not chemically interfere with the extruded film, but which may be uniformly dispersed throughout the film. Fillers may serve a variety of purposes, including enhancing film opacity and/or breathability (i.e., vapor-permeable and substantially liquid-impermeable). For instance, filled films may be made breathable by stretching, which causes the polymer to break away from the filler and create microporous passageways. Breathable microporous elastic films are described, for example, in U.S. Pat. Nos. 5,997,981; 6,015,764; and U.S. Pat. No. 6,111,163 to McCormack, et al.; U.S. Pat. No. 5,932,497 to Morman, et al.; U.S. Pat. No. 6,461,457 to Taylor, et al., which are incorporated herein in their entirety by reference thereto for all purposes.

The fillers may have a spherical or non-spherical shape with average particle sizes in the range of from about 0.1 to about 7 microns. Examples of suitable fillers include, but are not limited to, calcium carbonate, various kinds of clay, silica, alumina, barium carbonate, sodium carbonate, magnesium carbonate, talc, barium sulfate, magnesium sulfate, aluminum sulfate, titanium dioxide, zeolites, cellulose-type powders, kaolin, mica, carbon, calcium oxide, magnesium oxide, aluminum hydroxide, pulp powder, wood powder, cellulose derivatives, chitin and chitin derivatives. A suitable coating, such as stearic acid, may also be applied to the filler particles if desired. When utilized, the filler content may vary, such as from about 25 wt. % to about 75 wt. %, in some embodiments, from about 30 wt. % to about 70 wt. %, and in some embodiments, from about 40 wt. % to about 60 wt. % of the film.

Other additives may also be incorporated into the film, such as melt stabilizers, processing stabilizers, heat stabilizers, light stabilizers, antioxidants, heat aging stabilizers, whitening agents, antiblocking agents, bonding agents, tackifiers, viscosity modifiers, etc. Examples of suitable tackifier resins may include, for instance, hydrogenated hydrocarbon resins. REGALREZ™ hydrocarbon resins are examples of such hydrogenated hydrocarbon resins, and are available from Eastman Chemical. Other tackifiers are available from ExxonMobil under the ESCOREZ™ designation. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of films. Some suitable hindered phenols include those available from Ciba Specialty Chemicals of under the trade name “Irganox®”, such as Irganox® 1076, 1010, or E 201. Moreover, bonding agents may also be added to the film to facilitate bonding of the film to additional materials (e.g., nonwoven web). When employed, such additives (e.g., tackifier, antioxidant, stabilizer, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the film.

The elastic film may be mono- or multi-layered. Multilayer films may be prepared by co-extrusion of the layers, extrusion coating, or by any conventional layering process. Such multilayer films normally contain at least one base layer and at least one skin layer, but may contain any number of layers desired. For example, the multilayer film may be formed from a base layer and one or more skin layers, wherein the base layer is formed from a semi-crystalline polyolefin. In such embodiments, the skin layer(s) may be formed from any film-forming polymer. If desired, the skin layer(s) may contain a softer, lower melting polymer or polymer blend that renders the layer(s) more suitable as heat seal bonding layers for thermally bonding the film to a nonwoven web. For example, the skin layer(s) may be formed from an olefin polymer or blends thereof, such as described above. Additional film-forming polymers that may be suitable for use, alone or in combination with other polymers, include ethylene vinyl acetate, ethylene ethyl acrylate, ethylene acrylic acid, ethylene methyl acrylate, ethylene normal butyl acrylate, nylon, ethylene vinyl alcohol, polystyrene, polyurethane, and so forth.

The thickness of the skin layer(s) is generally selected so as not to substantially impair the elastomeric properties of the film. To this end, each skin layer may separately comprise from about 0.5% to about 15% of the total thickness of the film, and in some embodiments from about 1% to about 10% of the total thickness of the film. For instance, each skin layer may have a thickness of from about 0.1 to about 10 micrometers, in some embodiments from about 0.5 to about 5 micrometers, and in some embodiments, from about 1 to about 2.5 micrometers. Likewise, the base layer may have a thickness of from about 1 to about 40 micrometers, in some embodiments from about 2 to about 25 micrometers, and in some embodiments, from about 5 to about 20 micrometers.

The properties of the resulting film may generally vary as desired. For instance, prior to stretching, the film typically has a basis weight of about 100 grams per square meter or less, and in some embodiments, from about 50 to about 75 grams per square meter. Upon stretching, the film typically has a basis weight of about 60 grams per square meter or less, and in some embodiments, from about 15 to about 35 grams per square meter. The stretched film may also have a total thickness of from about 1 to about 100 micrometers, in some embodiments, from about 10 to about 80 micrometers, and in some embodiments, from about 20 to about 60 micrometers.

Although the backing is described as a film above, it should be understood that the backing can also be in the form of parallel elastic filaments, which includes ribbons.

### Lamination

In some implementations, laminating the non-woven material to the film involves for example, thermal bonding, adhesive bonding, ultrasonic bonding, pressure bonding, pin aperturing, or some combination thereof.

In some implementations, to concurrently form apertures and bonds between the film and the nonwoven web material, lamination is generally accomplished through a patterned bonding technique (e.g., thermal point bonding, ultrasonic bonding, etc.) in which the materials are supplied to a nip defined by at least one patterned roll. An example of this concurrent aperturing and bonding is described in U.S. Pat. No. 7,803,244 to Siqueira et al., which is incorporated herein in its entirety by reference thereto for all purposes. Thermal point bonding, for instance, typically employs a nip formed between two rolls, at least one of which is patterned. Ultrasonic bonding, on the other hand, typically employs a nip formed between a sonic horn and a patterned roll.

More specifically, the patterned roll, for example, contains a plurality of raised bonding elements to concurrently bond the film to the nonwoven web material(s) and form apertures in the film. The size of the bonding elements may be specifically tailored to facilitate the formation of apertures in the film and enhance bonding between the film and the nonwoven material(s). For example, the bonding elements are typically selected to have a relatively large length dimension. The length dimension of the bonding elements may be from about 300 to about 5000 micrometers, in some embodiments from about 500 to about 4000 micrometers, and in some embodiments, from about 1000 to about 2000 micrometers. The width dimension of the bonding elements may likewise range from about 20 to about 500 micrometers, in some embodiments from about 40 to about 200 micrometers, and in some embodiments, from about 50 to about 150 micrometers. In addition, the “element aspect ratio” (the ratio of the length of an element to its width) may range from about 2 to about 100, in some embodiments from about 4 to about 50, and in some embodiments, from about 5 to about 20.

Besides the size of the bonding elements, the overall bonding pattern may also be selectively controlled to achieve the desired aperture formation. In one embodiment, for example, a bonding pattern is selected in which the longitudinal axis (longest dimension along a center line of the element) of one or more of the bonding elements is skewed relative to the machine direction (“MD”) of the elastic film. For example, one or more of the bonding elements may be oriented from about 30° to about 150°, in some embodiments from about 45° to about 135°, and in some embodiments, from about 60° to about 120° relative to the machine direction of the film. In this manner, the bonding elements will present a relatively large surface to the film in a direction substantially perpendicular to that which the film moves. This increases the area over which shear stress is imparted to the film and, in turn, facilitates aperture formation.

The pattern of the bonding elements is generally selected so that the nonwoven composite has a total bond area of less than about 50% (as determined by conventional optical microscopic methods). In some implementations, the film is tensioned and then laminated to the non-woven web with a total bond area of between 5% and 30%.

In some implementations, the bond density is also typically greater than about 50 bonds per square inch, and in some embodiments, from about 75 to about 500 pin bonds per square inch. One suitable bonding pattern for use with this new elastomeric laminate is known as an “S-weave” pattern and is described in U.S. Pat. No. 5,964,742 to McCormack, et al., which is incorporated herein in its entirety by reference thereto for all purposes. S-weave patterns typically have a bonding element density of from about 50 to about 500 bonding elements per square inch, and in some embodiments, from about 75 to about 150 bonding elements per square inch. Another suitable bonding pattern is known as the “rib-knit” pattern and is described in U.S. Pat. No. 5,620,779 to Levy, et al., which is incorporated herein in its entirety by reference thereto for all purposes. Rib-knit patterns typically have a bonding element density of from about 150 to about 400 bonding elements per square inch, and in some embodiments, from about 200 to about 300 bonding elements per square inch. Yet another suitable pattern is the “wire weave” pattern, which has a bonding element density of from about 200 to about 500 bonding elements per square inch, and in some embodiments, from about 250 to about 350 bonding elements per square inch. Other bond patterns that may be used are described in U.S. Pat. No. 3,855,046 to Hansen et al.; U.S. Pat. No. 5,962,112 to Haynes et al.; U.S. Pat. No. 6,093,665 to Sayovitz et al.; D375,844 to Edwards, et al.; D428,267 to Romano et al.; and D390,708 to Brown, which are incorporated herein in their entirety by reference thereto for all purposes.

To achieve such concurrent aperture and bond formation without substantially softening the polymer(s) of the nonwoven web material, the bonding temperature and pressure may be selectively controlled. For example, one or more rolls may be heated to a surface temperature of from about 50° C. to about 160° C., in some embodiments from about 60° C. to about 140° C., and in some embodiments, from about 70° C. to about 120° C. Likewise, the pressure exerted by rolls (“nip pressure”) during thermal bonding may range from about 75 to about 600 pounds per linear inch, in some embodiments from about 100 to about 400 pounds per linear inch, and in some embodiments, from about 120 to about 200 pounds per linear inch. Of course, the residence time of the materials may influence the particular bonding parameters employed.

As stated, another factor that influences concurrent aperture and bond formation is the degree of tension in the film during lamination. An increase in film tension, for example, typically correlates to an increase in aperture size. Of course, a film tension that is too high may adversely affect the integrity of the film. Thus, in some implementations, a stretch ratio of about 1.5 or more, or 2 to 6 or 2.5 to 7.0, or 3.0 to 5.5, is used to achieve the desired degree of tension in the film during lamination. The stretch ratio may be determined by dividing the final length of the film by its original length. The stretch ratio may also be approximately the same as the draw ratio, which may be determined by dividing the linear speed of the film during lamination (e.g., speed of the nip rolls) by the linear speed at which the film is formed (e.g., speed of casting rolls or blown nip rolls).

The film may be “pre-stretched” (prior to lamination) by rolls rotating at different speeds of rotation so that the sheet is stretched to the desired stretch ratio in the machine direction. For example, the film may be stretched to a ratio of between 2 and 6 in the machine direction, i.e., 2 to 6 times the film's unstretched length. This uniaxially stretched film may also be oriented in the cross-machine direction to form a “biaxially stretched” film. The orientation temperature profile during the “pre-stretching” operation is generally below the melting point of one or more polymers in the film, but high enough to enable the composition to be drawn or stretched. For example, the film may be stretched at a temperature from about 15° C. to about 50° C., in some embodiments from about 25° C. to about 40° C., and in some embodiments, from about 30° C. to about 40° C. When “pre-stretched” in the manner described above, the degree of stretch during lamination may be increased, maintained, or slightly reduced (retracted) to desired degree of tension.

In other implementations, the lamination process does not involve aperturing the film, but rather is directed to bonding the film to the nonwoven web material (e.g., extensible or elastomeric facing). Laminating without intentionally creating apertures can be accomplished through, for example, thermal bonding, adhesive bonding, ultrasonic bonding, and/or pressure bonding.

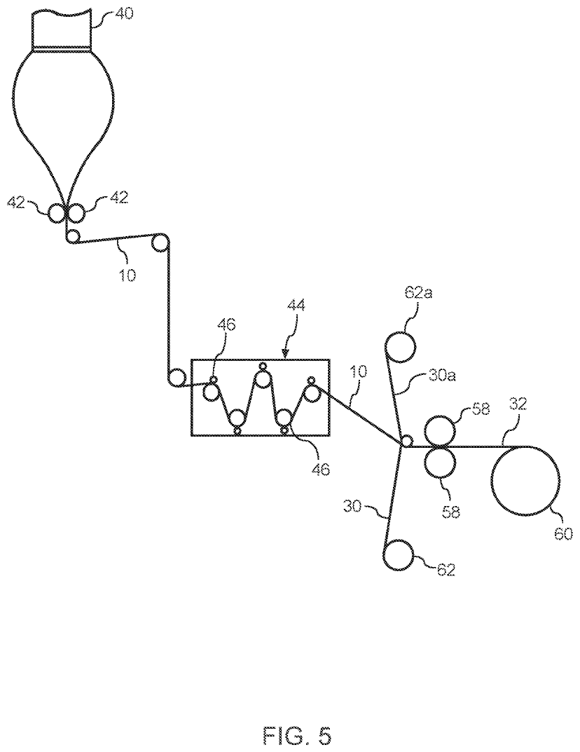

FIG. 5 shows an example method for forming a composite from an elastic film and a nonwoven web material. The raw materials of the film backing (e.g., elastomeric polymer) may be dry mixed together (i.e., without a solvent) and added to a hopper (not shown) of an extrusion apparatus 40. The raw materials may alternatively be blended with a solvent. In the hopper, the materials are dispersively mixed in the melt and compounded, such as, batch and/or continuous compounding techniques that employ, for example, a Banbury mixer, Farrel continuous mixer, single screw extruder, twin screw extruder, etc.

The compounded material (not shown) supplied to the extrusion apparatus 40 is then blown into nip rolls 42 to form a single-layered precursor elastic film 10. The rolls 42 may be kept at temperature sufficient to solidify and quench the precursor elastic film 10 as it is formed, such as from about 20 to 60° C. Typically, the resulting precursor elastic film is generally unapertured, although it may of course possess small cuts or tears as a result of processing.

The film 10 is stretched and thinned in the machine direction by passing it through a film-orientation unit or machine direction orienter (“MDO”) 44, such as commercially available from Marshall and Willams, Co. of Providence, R.I. In some implementations, the MDO has a plurality of stretching rolls 46 that progressively stretch and thin the film 10 in the machine direction. While four pairs of rolls 46 are illustrated in FIG. 5, it should be understood that the number of rolls may be higher or lower, depending on the level of stretch that is desired and the degrees of stretching between each roll. The film 10 may also be stretched in other directions. For example, the film 10 may be clamped at its lateral edges by chain clips and conveyed into a tenter oven. In the tenter oven, the film 10 may be drawn in the cross-machine direction to the desired stretch ratio by chain clips diverged in their forward travel.

In accordance with the present disclosure, at least one side of the elastic backing 10 is laminated to a nonwoven material in accordance with the present disclosure. In the embodiment illustrated in FIG. 5, for instance, the film 10 is laminated on one side to a first nonwoven material and laminated on an opposite side to a second nonwoven material. Each nonwoven material can be made inline or can be unwound from a supply roll. In the embodiment illustrated in FIG. 5, the first nonwoven material 30 is unwound from a supply roll 62 while the second nonwoven material 30a is unwound from a supply roll 62a. As shown, the nonwoven materials 30 and 30a are placed adjacent to the film 10 and bonded to the film.

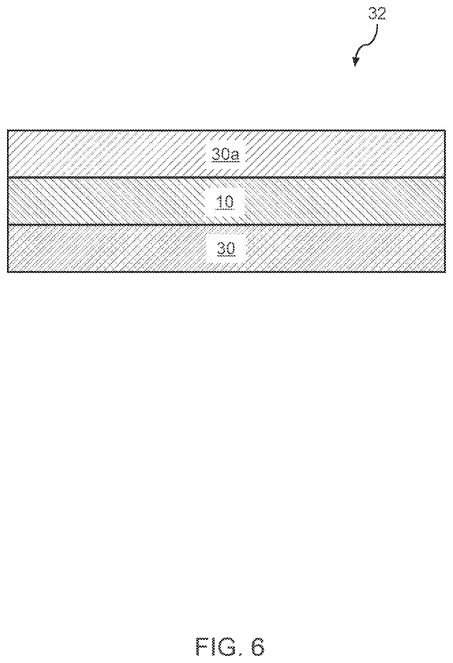

Although other processes can be used such as adhesive bonding, ultrasonic bonding, pressure bonding, and/or pin aperturing, in some implementations, thermal bonding techniques are used to laminate the nonwoven web material(s) to the elastic film 10. In FIG. 5, for example, the materials 30 and 30a are directed to a nip defined between rolls 58 for laminating to the elastic film 10. One or both of the rolls 58 may contain a plurality of raised bonding elements and/or may be heated. Upon lamination, the elastic film 10 is melt fused to the nonwoven web materials 30 and 30a at a plurality of discrete bond sites. That is, the elastomeric polymer(s) of the film 10 are softened and/or melted so that they may physically entrap fibers of the nonwoven web materials 30 and 30a. The elastic film 10 may possess a certain tack so that it also adheres to the fibers upon lamination. The resulting laminate 32 is shown, for example, in FIG. 6, which is a block representation of an elastomeric laminate.

The resulting laminate 32 may then be wound and stored on a take-up roll 60. Optionally, the laminate 32 is kept under tension, such as by using the same linear velocity for the roll 60 as the speed of one or more of the stretching rolls 46. However, the composite 32 may be allowed to slightly retract prior to winding on to the take-up roll 60. This may be achieved by using a slower linear velocity for the roll 60.

Because, in some implementations, the elastic film 10 is tensioned prior to lamination, it will, after the tensioned is removed, retract toward its original machine direction length and become shorter in the machine direction, thereby buckling or forming gathers in the laminate 32. The resulting elastic laminate 32 thus becomes extensible in the machine direction to the extent that the gathers or buckles in the laminate 32 may be pulled back out flat and then stretched further by virtue of the extensible nature of the nonwoven web 30, as described above, thereby allowing the elastic film 10 to elongate and even stretch beyond its tensioned length in the machine direction. Further, this extensible laminate 32 (e.g., the nonwoven web 30 bonded to the film 10) can be extensible or elastomeric in the cross-machine direction as the extensible nonwoven web 30 (and the film 10) permit such bi-axial stretching (i.e., stretching in the machine and cross-machine directions).

In some implementations, the laminate 32 may be mechanically stretched in the cross-machine and/or machine directions to enhance extensibility. In one implementation, the laminate 32 may be coursed through two or more rolls that have grooves in the CD and/or MD directions. Such grooved satellite/anvil roll arrangements are described in U.S. patent application Publication Nos. 2004/0110442 to Rhim, et al. and 2006/0151914 to Gerndt, et al., which are incorporated herein in their entirety by reference thereto for all purposes. For instance, the laminate 32 may be coursed through two or more rolls that have grooves in the CD and/or MD directions. The grooved rolls may be constructed of steel or other hard material (such as a hard rubber).

Besides the above-described grooved rolls, other techniques may also be used to mechanically stretch the laminate 32 in one or more directions. For example, the laminate 32 may be passed through a tenter frame that stretches the laminate 32. Such tenter frames are well known in the art and described, for instance, in U.S. patent application Publication No. 2004/0121687 to Morman, et al. The laminate 32 may also be necked. Suitable techniques necking techniques are described in U.S. Pat. Nos. 5,336,545, 5,226,992, 4,981,747 and 4,965,122 to Morman, as well as U.S. patent application Publication No. 2004/0121687 to Morman, et al., all of which are incorporated herein in their entirety by reference thereto for all purposes.

The laminate 32 described above may be used in a wide variety of applications. As noted above, for example, the laminate 32 may be used in an absorbent article.

Elastic laminates made according to the present disclosure can have an excellent balance of properties, namely excellent softness in combination with great strength properties. For instance, the elastic laminate can display an average burst strength of greater than about 1800 g_{f}, such as greater than about 1900 g_{f}, such as greater than about 2000 g_{f}, such as greater than about 2200 g_{f}, such as greater than about 2400 g_{f}, such as greater than about 2600 g_{f}, such as greater than about 2800 g_{f}, such as greater than about 3000 g_{f}, and generally less than about 5000 g_{f}.

The laminate can also display a stretch-to-stop at 2000 g in the machine direction of greater than about 170%, such as greater than about 175%, and generally less than about 225%. In the cross direction, the laminate can display a stretch-to-stop at 2000 g of from about 25% to about 70%, such as from about 45% to about 70%. The laminate can display an average load at 50% elongation in the machine direction of greater than about 320 g_{f}, such as greater than about 350 g_{f}, such as greater than about 370 g_{f}, and generally less than about 420 g_{f}, such as less than about 400 g_{f}. In the cross direction, the average load at 50% elongation can be greater than about 1500 g_{f}, such as greater than about 1600 g_{f}, such as greater than about 1700 g_{f}, such as greater than about 1800 g_{f}, and generally less than about 2200 g_{f}.

The average elongation at burst of the laminate can be greater than about 5.3%, such as greater than about 5.4%, such as greater than about 5.5%, such as greater than about 5.6%, and generally less than about 6%, such as less than about 5.9%. The average energy to peak load of the elastic laminate can generally be greater than about 4000 gf·cm, such as greater than about 4100 gf·cm, such as greater than about 4200 gf·cm, such as greater than about 4300 gf·cm, and generally less than about 7000 gf·cm.

The elastic laminate can also have excellent air permeability properties. For instance, the laminate can display an air permeability of greater than about 35 cfm, such as greater than about 45 cfm, such as greater than about 55 cfm, such as greater than about 60 cfm, such as greater than about 65 cfm, such as greater than about 70 cfm, and generally less than about 200 cfm.

With respect to handfeel, the laminate can display an average drape coefficient of less than about 55, such as less than about 45, such as less than about 35, such as less than about 25, such as less than about 15, and generally greater than about 10.

All of the above physical properties can be achieved with a single-faced or a dual-faced elastic laminate made according to the present disclosure that can have a basis weight of less than about 40 gsm, such as less than about 35 gsm, such as less than about 30 gsm, such as less than about 25 gsm, such as less than about 23 gsm, such as less than about 20 gsm, such as less than about 18 gsm, such as less than about 16 gsm, such as less than about 14 gsm, and greater than about 12 gsm.

In one embodiment, the present disclosure is directed to a nonwoven material comprising a strength building layer comprising spunbond fibers randomly arranged to form a web; the spunbond fibers can have a denier of less than about 2, such as less than about 1.1 and can be made from a non-elastomeric polymer. The nonwoven material can also have a softness enhancing layer comprising spunbond fibers randomly arranged to form a web; the softness enhancing layer can comprise a top layer of the nonwoven material, wherein the spunbond fibers contained in the softness enhancing layer comprise elastomeric fibers.

In one embodiment, the nonwoven material contains two or more strength building layers. In one embodiment, the nonwoven material contains two or more softness enhancing layers. In one embodiment, the nonwoven material contains two or more softness enhancing layers and two or more strength building layers.

In any of the above embodiments, the strength building layer(s) can be present in relation to the softness enhancing layer(s) at a weight ratio of from about 1:4 to about 4:1, such as from about 1:3 to about 3:1, such as from about 1:3 to about 1.5:1, such as from about 1:2 to about 1.1:1.

In one embodiment, any of the embodiments of the nonwoven material described above can be incorporated into an elastomeric laminate. In one embodiment, the laminate comprises an elastic backing attached to the nonwoven material. In one embodiment, the backing comprises an elastic film having a first surface and a second surface. In one embodiment, the nonwoven material is attached to the first surface of the elastic film. In another embodiment, a first nonwoven material is attached to the first surface of the elastic film and a second nonwoven material is attached to the second surface of the elastic film. In one embodiment, the strength building layer of the nonwoven material(s) can be attached to the elastic film and the softness enhancing layer(s) can form an exterior surface of the laminate.

The present disclosure may be better understood with reference to the following examples.

### Test Procedures

### Air Permeability Test

The Air Permeability Test measures the rate of air-flow through a known dry specimen area. The air permeability of each sample was measured using a Textest FX3300 air permeability tester available from Schmid Corporation, having offices in Spartanburg, S.C.

A specimen from each test sample was cut and placed so that the specimen extended beyond the clamping area of the air permeability tester. The test specimens were obtained from areas of the sample that were free of folds, crimp lines, perforations, wrinkles, and/or any distortions that make them abnormal from the rest of the test material.

The tests were conducted in a standard laboratory atmosphere of 23±1° C. (73.4±1.8° F.) and 50+2% humidity. The instrument was turned on and allowed to warm up for at least 5 minutes before testing any specimens. The instrument was calibrated based on the manufacturer's guidelines before the test material was analyzed. The pressure sensors of the instrument were reset to zero by pressing the NULL RESET button on the instrument. Before testing, and if necessary between samples or specimens, the dust filter screen was cleaned, following the manufacturer's instructions. The following specifications were selected for data collection: (a) Unit of measure: cubic feet per minute (cfm); (b) test pressure: 125 Pascal (water column 0.5 inch or 12.7 mm); and (c) test head: 38 square centimeters (cm.sup.2). Since test results obtained with different size test heads are not always comparable, samples to be compared should be tested with the same size test head.

The NULL RESET button was pressed prior to every series of tests, or when the red light on the instrument was displayed. The test head was open (no specimen in place) and the vacuum pump was at a complete stop before the NULL RESET button was pressed.

Each specimen was placed over the lower test head of the instrument. The test was started by manually pressing down on the clamping lever until the vacuum pump automatically started. The Range Indicator light on the instrument was stabilized in the green or yellow area using the RANGE knob. After the digital display was stabilized, the air permeability of the specimen was displayed, and the value was recorded. The test procedure was repeated for 10 specimens of each sample, and the average value for each sample was recorded as the air permeability.

### Burst Strength Test

The Burst Strength Test measures the amount of force required to burst (i.e., rupture) a test sample using a constant rate of extension (CRE) tensile tester. The burst strength of each sample was measured using an MTS Criterion Model 42 tensile tester commercially available from MTS Systems Corporation.

A 4 inch by 4 inch (101.6 mm.times.101.6 mm) test specimen was cut from each test sample, and placed in a clamping fixture having a circular opening defining the test area. A penetration assembly having a smooth, spherical probe tip was arranged perpendicular to and centered under the circular test area. The penetration assembly consisted of a spherical probe tip affixed to the end of a socket, which was secured to the tensile tester with a lock nut. The Burst Strength Test was carried out according to TAPPI T570 pm-00, using a test speed of 6 inches per minute and a load cell of 50 Newtons. The penetration assembly was raised at the specified test speed such that the spherical probe tip contacted and eventually penetrated the test specimen to the point of specimen rupture. The maximum force applied by the penetration assembly at the instant of specimen rupture was recorded as the burst strength in grams-force (gf). The average value from 10 specimens of each test sample was recorded.

### Stretch to Stop Test

“Stretch-to-stop” refers to a ratio determined from the difference between the unextended dimension of a stretchable laminate and the maximum extended dimension of a stretchable laminate upon the application of a specified tensioning force and dividing that difference by the unextended dimension of the stretchable laminate. If the stretch-to-stop is expressed in percent, this ratio is multiplied by 100. For example, a stretchable laminate having an unextended length of 5 inches (12.7 cm) and a maximum extended length of 10 inches (25.4 cm) upon applying a force of 2000 grams has a stretch-to-stop (at 2000 grams) of 100 percent. Stretch-to-stop may also be referred to as “maximum non-destructive elongation.” Unless specified otherwise, stretch-to-stop values are reported herein at a load of 2000 grams. In the elongation or stretch-to-stop test, a 3-inch by 7-inch (7.62 cm by 17.78 cm) sample, with the larger dimension being the machine direction, the cross direction, or any direction in between, is placed in the jaws of a Sintech machine using a gap of 5 cm between the jaws. The sample is then pulled to a stop load of 2000 gms with a crosshead speed of about 20 inches/minute (50.8 cm/minute). For the stretchable laminate material of this invention, it is desirable that it demonstrate a stretch to stop value between about 30-400 percent, alternatively between about 50 and 300 percent, still in a further alternative, between about 80-250 percent. The stretch to stop test is done in the direction of extensibility (stretch). The above procedure can also be used to test average load at 50% elongation.

### Drape Coefficient Test

The Cusick drape test can be performed using any suitable drape tester to obtain a drape coefficient. Commercially available drape testers include TF118 tester marked by Testex of Dongguam, China or Model 665 drape tester marketed by James H Heal & Co. of Halifax, England. The drape test can be tested in accordance with ISO Test 9073-9 (2008).

### TS7 and TS750 Tests

TS7 and TS750 values were measured using an EMTEC Tissue Softness Analyzer (“TSA”) (Emtec Electronic GmbH, Leipzig, Germany) The TSA comprises a rotor with vertical blades which rotate on the test piece applying a defined contact pressure. Contact between the vertical blades and the test piece creates vibrations, which are sensed by a vibration sensor. The sensor then transmits a signal to a PC for processing and display. The signal is displayed as a frequency spectrum. For measurement of TS7 and TS750 values the blades are pressed against sample with a load of 100 mN and the rotational speed of the blades is 2 revolutions per second.

To measure TS7 and TS750 values two different frequency analyses are performed. The first frequency analysis is performed in the range of approximately 200 Hz to 1000 Hz, with the amplitude of the peak occurring at 750 Hz being recorded as the TS750 value. The TS750 value represents the surface smoothness of the sample. A high amplitude peak correlates to a rougher surface. A second frequency analysis is performed in the range from 1 to 10 kHZ, with the amplitude of the peak occurring at 7 kHz being recorded as the TS7 value. The TS7 value represents the softness of sample. A lower amplitude correlates to a softer sample. Both TS750 and TS7 values have the units dB V² rms.

### Strain and Load

Tensile properties of nonwoven materials were determined in substantial accordance with ASTM Standard D-5034.

Specifically, a nonwoven web sample was cut or otherwise provided with size dimensions that measured 25 millimeters (width)×127 millimeters (length). A constant-rate-of-extension type of tensile tester was employed. The tensile testing system was a Sintech Tensile Tester, which is available from Sintech Corp. of Cary, N.C. The tensile tester was equipped with TESTWORKS 4.08B software from MTS Corporation to support the testing. An appropriate load cell was selected so that the tested value fell within the range of 10-90% of the full scale load. The sample was held between grips having a front and back face measuring 25.4 millimeters×76 millimeters. The grip faces were rubberized, and the longer dimension of the grip was perpendicular to the direction of pull. The grip pressure was pneumatically maintained at a pressure of 40 pounds per square inch. The tensile test was run at a 300-millimeter per minute rate with a gauge length of 10.16 centimeters and a break sensitivity of 40%.

Five samples were tested. Strain was determined at a force of 2,000 g and load was determined at 50% in both the machine direction and the cross-machine direction. The results of five samples were averaged.

### Martindale Abrasion

This test can measure the relative resistance of a sample to abrasion according to Worldwide Strategic Partners (“WSP”) Standard Test No. 20.5 (08). A circular specimen of 165 mm±6.4 mm in diameter with an area of 18,258 sq mm is subjected to a requested number of cycles (10 or 60) with an abradant under a pressure of 9 kilopascals (kPa). The abradant is a 36 inch by 4 inch by 0.05 thick silicone rubber wheel reinforced with fiberglass having a rubber surface hardness 81A Durometer, Shore A of 81±9. The specimen is examined for the presence of surface fuzzing (fiber lofting), pilling (small dumps of fibers), roping, delamination or holes and assigned a numerical rating of 1, 2, 3, 4, or 5 based on comparison to a set of standard photographs similarly numbered, with “1” showing the greatest wear and “5” the least. The test is carried out with a Martindale Wear and Abrasion Tester such as Model No. 103 or 403 from James H. Heal & Company, Ltd. of West Yorkshire, England.

### Thermal Conductivity and Thermal Effusivity

The thermal effusivity of the sample was measured with a C-Therm TCi Thermal Conductivity Analyzer in accordance with ASTM D7984-16 Standard (“Test Method for Measurement of Thermal Effusivity of Fabrics Using a Modified Transient Plane Source (MTPS) Instrument.”) The default C-Therm TCi Thermal Conductivity Analyzer employs the Modified Transient Plane Source (MTPS) technique in characterizing the thermal conductivity and effusivity of materials. It employs a one-sided, interfacial heat reflectance sensor that applies a momentary constant heat source to the sample.

### Example No. 1

Various different elastic laminates were made in accordance with the present disclosure in which an elastic backing was attached to a facing on each side of the backing that was comprised of a strength-building layer and a softness enhancing layer. The strength-building layer was attached to the film backing.

The samples made in accordance with the present disclosure were compared with a similar laminate only containing elastomeric spunbond fibers on each side as a facing and an elastomeric laminate containing low denier polypropylene spunbond fibers on each side as a facing.

More particularly, the following samples were produced. In each sample, the elastic backing was a film. The film accounted for about 28% to about 37% of the basis weight of the laminate.

Sample No. 1: Each facing included a strength-building layer and a softness enhancing layer. The strength-building layer was attached to the film and comprised a 4 gsm spunbond web made from polypropylene fibers having a denier of about 1. The softness enhancing layer was a 6 gsm spunbond web made from bicomponent fibers containing an elastomeric core surrounded by a polyethylene sheath. The core contained two elastomeric polymers (a VERSIFY polymer and a VISTAMAXX polymer), a metallocene catalyzed polypropylene, and a secondary amide. The laminate was point bonded with a bond pattern that occupied about 15% to about 17% of the surface area.

Sample No. 2: Same construction as Sample No. 1 Sample No. 3: Same construction as Sample No. 1 only the strength-building layer had a basis weight of 5 gsm and the softness enhancing layer had a basis weight of 8.5 gsm.

Sample No. 4: The facing attached to the elastic backing comprised of only the softness enhancing layer as described in Sample No. 1. The facing on each side of the film had a basis weight of 17 gsm.

Sample No. 5: The facing attached to the elastic backing comprised of only the strength-building layer as described in Sample No. 1. The facing on each side of the film had a basis weight of 10 gsm.

The above samples were tested for various physical properties and the following results were obtained.

TABLE NO 1

| | | Average air |
|---|---|---|
| Sample | Average basis weight | permeability |
| No. | (gsm) | (cfm) |
| 1 | 89.30 | 74.26 |
| 2 | 86.19 | 69.90 |
| 3 | 102.91 | 36.56 |
| 4 | 128.57 | 18.00 |
| 5 | 88.82 | 100.24 |

TABLE NO 2

| | Average stretch to | Average stretch to | Average load at | Average load at |
|---|---|---|---|---|
| | stop at 2000 gf in | stop at 2000 gf in | 50% elongation in | 50% elongation in |
| Sample | the machine | the cross direction | the machine | the cross direction |
| No. | direction (%) | (%) | direction (gf) | (gf) |
| 1 | 181.03 | 50.83 | 343.60 | 1957.80 |
| 2 | 175.90 | 53.42 | 348.30 | 1877.36 |
| 3 | 175.92 | 33.18 | 399.00 | n/a |
| 4 | 226.73 | 71.96 | 451.30 | 1335.70 |
| 5 | 165.35 | 17.74 | 304.70 | n/a |

TABLE NO 3

| Sample | Average Burst | Average elongation | Average energy to |
|---|---|---|---|
| No. | Strength (gf) | at Burst (%) | peak load (gf · cm) |
| 1 | 2019.30 | 5.90 | 4483.70 |
| 2 | 1923.70 | 5.80 | 4111.80 |
| 3 | 2519.90 | 5.60 | 4971.50 |
| 4 | 1596.90 | 6.10 | 3913.70 |
| 5 | 4693.20 | 4.90 | 6930.80 |

TABLE NO 4

| Sample | | |
|---|---|---|
| No. | Average TS7 | Average TS750 |
| 1 | 5.289 | 58.325 |
| 2 | 5.660 | 59.827 |
| 3 | 5.008 | 85.164 |
| 4 | 3.140 | 93.339 |
| 5 | 7.970 | 50.050 |

TABLE NO 5

| Sample | |
|---|---|
| No. | Average Drape Coefficient |
| 1 | 50.09 |
| 2 | 51.45 |
| 3 | 57.30 |
| 4 | 32.72 |
| 5 | 64.51 |

### Example No. 2

More elastic laminates were made in accordance with the present disclosure having generally the same construction and made in the same way as described in Example No. 1 above.

Sample Nos. 6-23 were produced. Each sample included an elastic backing attached to a facing layer on each side. Sample Nos. 8-22 were made in accordance with the present disclosure wherein each facing included a strength building layer and a softness enhancing layer. The strength building layer was attached to the film backing.

Sample Nos. 6 and 7 included facing layers that were only comprised of elastomeric spunbond fibers. Sample No. 23, on the other hand, included facing layers that only contained low denier polypropylene spunbond fibers.

The elastomeric spunbond fibers and the low denier polypropylene spunbond fibers have the same construction as described in Example No. 1. However, Sample Nos. 15 and 16 both contained 5% by weight of an elastomeric polymer in the fibers of the strength building layer (VISTAMAXX polymer).

The elastic laminates were tested for various properties. Table Nos. 6, 7 and 8 display the results below.

TABLE NO 6

| | Total Facing | | | |
|---|---|---|---|---|
| Sample | Basis Wt | % wt. strength | Laminate Basis | Air perm |
| No. | (gsm) | building layer | Wt (gsm) | (cfm) |
| 6 | 36 | 0 | 147.3 | 2.5 |
| 7 | 34 | 0 | 139.3 | 9.5 |
| 8 | 36 | 25 | 143.4 | 13.0 |
| 9 | 28 | 25 | 120.9 | 18.1 |
| 10 | 28 | 40 | 121.0 | 26.3 |
| 11 | 20 | 40 | 98.1 | 63.4 |
| 12 | 28 | 40 | 115.5 | 20.1 |
| 13 | 28 | 50 | 121.9 | 47.7 |
| 14 | 20 | 50 | 88.7 | 78.2 |
| 15 | 28 | 50 | 114.8 | 49.5 |
| 16 | 28 | 40 | 113.7 | 40.7 |
| 17 | 28 | 70 | 130.1 | 47.8 |
| 18 | 28 | 70 | 105.5 | 57.4 |
| 19 | 20 | 70 | 109.8 | 67.8 |
| 20 | 28 | 60 | 111.2 | 47.5 |
| 21 | 20 | 60 | 82.2 | 63.1 |
| 22 | 28 | 40 | 115.6 | 19.1 |
| 23 | 22 | 100 | 90.6 | 129.8 |

TABLE NO 7

| Sample | MD Strain | MD Load | CD Strain | CD Load |
|---|---|---|---|---|
| No. | @ 2000 g (%) | @ 50% (gf) | @ 2000 g (%) | @ 50% (gf) |
| 6 | 219.7 | 413.6 | 77.0 | 1162.5 |
| 7 | 210.6 | 370.8 | 103.9 | 811.9 |
| 8 | 177.0 | 431.4 | 40.2 | Not tested |
| 9 | 194.3 | 366.6 | 68.6 | 1311.3 |
| 10 | 187.1 | 345.7 | 47.7 | Not tested |
| 11 | 201.0 | 305.3 | 83.7 | 1111.0 |
| 12 | 172.0 | 388.6 | 43.3 | Not tested |
| 13 | 174.8 | 327.8 | 37.2 | Not tested |
| 14 | 179.7 | 311.2 | 78.0 | 1189.3 |
| 15 | 182.9 | 351.3 | 35.1 | Not tested |
| 16 | 186.5 | 355.3 | 45.9 | Not tested |
| 17 | 180.1 | 337.2 | 28.6 | Not tested |
| 18 | 174.0 | 357.4 | 27.6 | Not tested |
| 19 | 184.5 | 294.3 | 51.7 | 1935.4 |
| 20 | 176.2 | 361.6 | 30.2 | Not tested |
| 21 | 178.7 | 309.7 | 60.2 | 1641.8 |
| 22 | 179.0 | 379.9 | 26.5 | Not tested |
| 23 | 166.8 | 261.4 | 17.9 | Not tested |

TABLE NO 8

| | | Burst | | | | | | | |
|---|---|---|---|---|---|---|---|---|---|
| | Burst | Energy To | | | | | | | |
| | Peak | Peak | Burst Peak | | | | Martindale | Thermal | |
| Sample | Load | Load | Elongation | | | Drape | Abrasion | Conductivity, | Thermal Effusivity, |
| No. | (gf) | (gf · cm) | (cm) | TS7 | TS750 | Coefficient | (cycles) | k (W/mK) | e (Ws½ m − 2K − 1) |
| 6 | 1574.7 | 3778.4 | 6.3 | 3.7 | 109.2 | 29.1 | Not tested | Not tested | Not tested |
| 7 | 1407.4 | 3230.1 | 6.3 | 3.3 | 99.5 | 26.4 | 2 | 0.044 | 112.5 |
| 8 | 2704.6 | 5799.6 | 6.1 | 3.9 | 150.7 | 45.9 | Not tested | Not tested | Not tested |
| 9 | 2172.8 | 4892.6 | 6.5 | 3.3 | 101.2 | 38.2 | 2 | 0.040 | 86.2 |
| 10 | 2289.9 | 5076.1 | 6.1 | 3.5 | 101.7 | 46.7 | 2.25 | 0.041 | 93.9 |
| 11 | 1648.2 | 3668.9 | 6.3 | 3.7 | 55.1 | 30.1 | 2.5 | 0.039 | 79.2 |
| 12 | 2802.0 | 6224.9 | 6.3 | 3.4 | 113.2 | 46.5 | 4 | 0.038 | 75.5 |
| 13 | 2313.4 | 4770.9 | 5.7 | 3.7 | 85.7 | 48.0 | 3.5 | 0.039 | 79.2 |
| 14 | 1806.6 | 4006.0 | 6.4 | 3.6 | 51.6 | 33.3 | 2.5 | Not tested | Not tested |
| 15 | 2756.5 | 6281.9 | 6.2 | 3.7 | 85.6 | 48.3 | Not tested | Not tested | Not tested |
| 16 | 2449.4 | 5621.3 | 6.4 | 3.7 | 94.0 | 45.8 | Not tested | Not tested | Not tested |
| 17 | 2583.6 | 5440.8 | 5.6 | 4.2 | 95.1 | 53.3 | Not tested | Not tested | Not tested |
| 18 | 2583.6 | 5440.8 | 5.6 | 4.0 | 88.4 | 55.1 | 3.5 | 0.037 | 67.7 |
| 19 | 2673.9 | 5167.5 | 5.5 | 3.9 | 62.3 | 44.7 | 2.5 | 0.039 | 77.7 |
| 20 | 2013.4 | 4296.2 | 6.0 | 3.9 | 91.0 | 52.2 | 3.75 | 0.039 | 80.3 |
| 21 | 2643.1 | 5179.7 | 5.6 | 3.9 | 61.7 | 45.6 | 2.75 | Not tested | Not tested |
| 22 | 1950.2 | 4155.2 | 6.0 | 3.1 | 90.0 | 53.4 | Not tested | Not tested | Not tested |
| 23 | 4691.5 | 6949.7 | 4.9 | 5.0 | 52.2 | 57.2 | 5 | 0.036 | 56.4 |

As shown in the examples above, laminates made according to the present disclosure display an excellent combination of properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A nonwoven material comprising:
a strength building layer comprising spunbond fibers randomly arranged to form a web, the spunbond fibers having a denier of less than about 2 and being made from a non-elastomeric polymer; and
a softness enhancing layer comprising spunbond fibers randomly arranged to form a web, the softness enhancing layer comprising a top layer of the nonwoven material, the spunbond fibers contained in the softness enhancing layer comprising elastomeric fibers.

2. The nonwoven material as defined in claim 1, wherein the nonwoven material contains two or more strength building layers.

3. The nonwoven material as defined in claim 1, wherein the nonwoven material contains two or more softness enhancing layers.

4. The nonwoven material as defined in claim 1, wherein the nonwoven material contains two or more softness enhancing layers and two or more strength building layers.

5. The nonwoven material as defined in claim 1, wherein the spunbond fibers contained in the strength building layer are made from a polypropylene polymer, wherein the polypropylene polymer comprises at least about 70% by weight of the spunbond fibers contained in the strength building layer.

6. (canceled)

7. The nonwoven material as defined in claim 1, wherein the spunbond fibers contained in the strength building layer have a denier of less than about 1.3.

8. The nonwoven material as defined in claim 1, wherein the spunbond fibers contained in the softness enhancing layer comprise elastomeric bicomponent fibers, the bicomponent fibers including a core surrounded by a sheath.

9. The nonwoven material as defined in claim 8, wherein the core of the bicomponent fibers comprises a polypropylene-based elastomer and a secondary amide.

10. The nonwoven material as defined in claim 9, wherein the polypropylene-based elastomer comprises an ethylene copolymer, α-olefin copolymer, or a combination thereof.

11. The nonwoven material as defined in claim 9, wherein the sheath comprises a non-elastomeric polymer.

12. The nonwoven material as defined in claim 9, wherein the sheath comprises a polyethylene polymer.

13. The nonwoven material as defined in claim 9, wherein the secondary amide is a fatty acid amide.

14. The nonwoven material as defined in claim 9, wherein the secondary amide comprises a structure having one of the following: 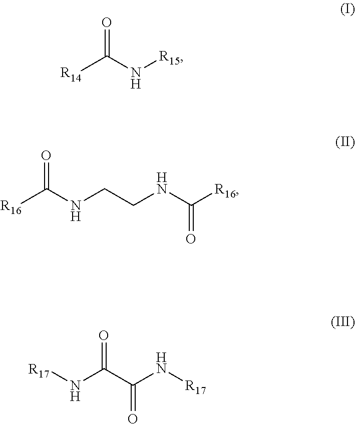
wherein,
R14, R15, R16, and R18 are independently selected from C7-C27 alkyl groups and C7-C27 alkenyl groups; and
R17 is selected from C8-C28 alkyl groups and C8-C28 alkenyl groups.

15. The nonwoven material as defined in claim 9, wherein the core contains a second elastomer.

16. The nonwoven material as defined in claim 1, wherein the nonwoven material has a basis weight of from about 5 gsm to about 170 gsm.

17. The nonwoven material as defined in claim 1, wherein the nonwoven material has a basis weight of from about 9 gsm to about 30 gsm.

18. The nonwoven material as defined in claim 1, wherein the strength building layer is present in relation to the softness enhancing layer at a weight ratio of from about 1:4 to about 4:1.

19. An elastomeric laminate comprising a nonwoven material as defined in claim 1.

20. The elastomeric laminate as defined in claim 19, wherein the laminate comprises a backing attached to the nonwoven material, the backing comprising elastic film having a first surface and a second surface and wherein the strength building layer is attached to the first surface of the elastic film, wherein a second nonwoven material is attached to the second surface of the backing and wherein the strength building layer of the second nonwoven material is attached directly to the second surface of the elastic film.

21. The elastomeric laminate as defined in claim 19, wherein the nonwoven material has a basis weight of from about 9 gsm to about 30 gsm, and wherein the elastomeric laminate has a burst strength of greater than about 1800 gf.

22. The elastomeric laminate as defined in claim 19, wherein the elastomeric laminate has an average STS at 2,000 g in a machine direction of greater than about 170 gf.

23. (canceled)

24. The elastomeric laminate as defined in claim 19 wherein the elastomeric laminate has an average TS7 of less than about 6.

25. The elastomeric laminate as defined in claim 19 wherein the elastomeric laminate displays an average drape coefficient of less than about 55.
